(19) United States
(12) Patent Application Publication
(10) Pub. No.: US 2026/0187637 A1
(43) Pub. Date: Jul. 2, 2026

(54) SYSTEM AND METHOD FOR AUTOMATIC DETECTION AND ENGAGEMENT WITH FRAUDULENT ACTORS

(71) Applicant: Advaith Venkatramanan Sethuraman, Fremont, CA (US)

(72) Inventor: Advaith Venkatramanan Sethuraman, Fremont, CA (US)

(21) Appl. No.: 19/006,214

(22) Filed: Dec. 30, 2024

(51) Int. Cl. G06Q 20/40

(52) U.S. Cl. CPC G06Q 20/4016

(57) ABSTRACT

Disclosed is a system and method for automatic detection and engagement with fraudulent actors. In one embodiment, a method includes identifying a natural language text of a correspondence suspected of describing a fraudulent solicitation using a fraud detection machine learning model using a processor and a memory. The method includes determining that the correspondence from a sender is a solicitation designed to fraudulently convince a recipient to transfer funds to the sender that conveyed the correspondence based on the analysis of the natural language text using the fraud detection machine learning model. The method includes providing the natural language text in a context window to a fine-tuned version of a language model that is optimized based on scam phraseology. The method includes analyzing the natural language text using the fine-tuned version of the language model.

### FIELD OF TECHNOLOGY

This disclosure relates generally to the field of systems and methods for automatic detection and engagement with fraudulent actors, according to one embodiment.

### BACKGROUND

A fraudulent scheme and/or scam may be a deceptive practice designed to manipulate individuals into providing money, sensitive information, and/or other valuable resources. Fraudulent schemes and scams have proliferated across various communication platforms, including but not limited to phone calls, text messages, emails, and/or instant messaging apps. These scams may exploit unsuspecting individuals, which may cause significant emotional, financial, and/or physical distress. Scam victims may lose savings, fall prey to identity theft, and/or face other severe consequences due to the deceptive tactics employed by scammers.

Victims often feel humiliated, guilty, and/or overwhelmed by the consequences of falling prey to such fraudulent schemes and scams. Furthermore, law enforcement and regulatory bodies may face immense challenges in allocating resources effectively to investigate and combat scams, especially given the global and distributed nature of these activities.

Scambaiting may be a practice where individuals and/or automated computer systems attempt to engage scammers to waste their time and resources. Scambaiting may be reactive as scambaiting activities may be initiated only after an individual is targeted and a scam is underway. While these approaches may disrupt scams after they begin, they may fail to prevent the initial contact and/or proactively hinder the operations of scammers. Consequently, scammers may refine their techniques and target additional victims, perpetuating a cycle of harm.

Moreover, existing scambaiting tools may suffer from limitations in scope. Many communication platforms, including but not limited to encrypted messaging apps and/or ephemeral social media channels, may lack APIs and/or direct monitoring capabilities. This may hinder fraud detection protocols within scambaiting systems from adequately tracking and intercepting scam activities across all channels. The lack of interoperability between detection mechanisms may further compound the issue, as scammers may easily transition from one platform to another without losing the ability to manipulate victims.

Scambaiting efforts may rely heavily on manual intervention. Manual intervention may focus on engaging scammers in deceptive conversations to waste their time and resources, but manual intervention may fail to systematically disrupt the scammers' infrastructure and/or gather actionable intelligence that could aid in dismantling their networks.

Reactive scambaiting measures may be insufficient to address the growing sophistication and scale of scam operations. As such, individuals, organizations, and society at large may continue to be harmed.

Other features will be apparent from the accompanying drawings and from the detailed description that follows.

### SUMMARY

In one aspect, a method comprises identifying a natural language text of a correspondence suspected of describing a fraudulent solicitation using a fraud detection machine learning model using a processor and a memory. The method determines that the correspondence from a sender is a solicitation designed to fraudulently convince a recipient to transfer funds to the sender that conveyed the correspondence based on the analysis of the natural language text using the fraud detection machine learning model. The method provides the natural language text in a context window to a fine-tuned version of a language model that is optimized based on scam phraseology. The method analyzes the natural language text using the fine-tuned version of the language model. The method automatically generates a responsive communication to the sender as an output to the fine-tuned version of the language model based on the natural language text in the context window. The responsive communication is crafted to encourage the sender to reply to the responsive communication with a reply message. The method transmits the responsive communication to the sender. The method recursively engages with the sender by passing the reply message through the fine-tuned version of the natural language model to collect information of the sender.

The method may collect metadata from the correspondence and/or the reply message. The method may process the metadata from the correspondence and/or the reply message to form a historical data. The method may store the historical data in the memory. The method may compare the correspondence and/or the reply message to the historical data to determine if the sender is at least one of a known party and/or an unknown party by analyzing cross-platform activities and/or by unifying scam-related communications across different platforms using an unique identifier extrapolated from the metadata and/or the historical data.

The method may generate a profile for the unknown party comprising at least one of a raw version of the correspondence, a raw version of the reply message, a sender-specific metadata, and/or the historical data. The method may store the profile within the memory for future reference and/or analysis. Upon creating the profile, the unknown party may become the known party. The method may send the unknown party a bait message that may be designed to encourage the unknown party to reply to the bait message. The bait message may be sent from a centralized chat engine that is not associated with the recipient. The method may integrate the fraud detection machine learning model and/or the fine-tuned version of the language model within a communication application that may facilitate communication between the sender and the recipient through an accessibility setting.

The method may analyze a response behavior of the sender of the correspondence and/or the reply message using behavioral analytics. The method may dynamically adjust the responsive communication based on the response behavior of the sender by shifting at least one of tone, urgency, and/or message content to elicit further engagement from the sender. The method may adapt conversation flow in real-time using machine learning techniques to maximize data extraction from the sender. The method may enable real-time updates to at least one of the fraud detection machine learning model and/or the fine-tuned version of the language model based on the metadata collected from the correspondence and/or the reply message. The method may alert the recipient that the correspondence is suspected of describing the fraudulent solicitation.

In yet another aspect, a method comprises identifying a natural language text of a correspondence suspected of describing a fraudulent solicitation using a fraud detection machine learning model using a processor and a memory. The method determines that the correspondence from a sender is designed to fraudulently convince a recipient to transfer funds to the sender that conveyed the correspondence based on the analysis of the natural language text using the fraud detection machine learning model. The method provides the natural language text in a context window to a fine-tuned version of a language model that is optimized based on scam phraseology. The method analyzes the natural language text using the fine-tuned version of the language model. The method collects a metadata and a raw version of the correspondence from the correspondence. The method compares the metadata and the raw version of the correspondence to a historical data to determine if the sender is an unknown party by analyzing cross-platform activities and unifying scam-related communications across different platforms using an unique identifier extrapolated from the metadata and the historical data.

The method automatically generates a bait message as an output to the fine-tuned version of the language model based on the metadata and the historical data in the context window. The bait message is crafted to encourage the unknown party to reply to the bait message with a reply message. The method transmits the bait message to the unknown party from a centralized chat engine. The method recursively engages with the unknown party by passing the reply message through the fine-tuned version of the language model to waste the unknown party's time and resources.

The method may process the metadata and/or the raw version of the correspondence and/or a raw version of the reply message to form the historical data. The method may store the historical data in the memory. The method may generate a profile for the unknown party comprising sender-specific historical data. The method may store the profile within the memory for future reference and/or analysis. Upon creating the profile, the unknown party may become a known party. The method may integrate the fraud detection machine learning model and/or the fine-tuned version of the language model within a communication application that may facilitate communication between the sender and/or the recipient through an accessibility setting.

The method may analyze a response behavior of the sender of the correspondence and/or the reply message using behavioral analytics. The method may dynamically adjust the bait message based on the response behavior of the sender by shifting at least one of tone, urgency, and/or message content to elicit further engagement from the sender. The method may adapt conversation flow in real-time using machine learning techniques to maximize data extraction from the sender. The method may enable real-time updates to at least one of the fraud detection machine learning model and/or the fine-tuned version of the language model based on the metadata collected from the correspondence and/or the reply message.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1A is a flow diagram illustrating a scambaiting system for detecting, analyzing, and responding to a correspondence suspected of describing a fraudulent solicitation, according to one or more embodiments.

FIG. 1B is a flow diagram illustrating the scambaiting system of FIG. 1A wherein a responsive communication to a sender is crafted in a manner to encourage the sender to reply to the recipient with a reply message, according to one or more embodiments.

FIG. 2 is a diagram illustrating an engagement hub of the scambaiting system of FIGS. 1A-1B, according to one or more embodiments.

FIG. 3 is a flow diagram illustrating the steps involved in processing the correspondence (e.g,. a raw version of the correspondence), the reply message (e.g., a raw version of the reply message), metadata, and historical data within the scambaiting system of FIGS. 1A-2 to distinguish between an unknown party and a known party, generate profiles, and update sender information, according to one or more embodiments.

FIG. 4 is a flow diagram illustrating the generation and transmission of a bait message by the scambaiting system of FIGS. 1A-3, according to one or more embodiments.

FIG. 5 is a network diagram illustrating the infrastructure of the scambaiting system of FIGS. 1A-4, according to one or more embodiments.

FIG. 6A is a flow diagram illustrating an integration view of the scambaiting system of FIGS. 1A-5, according to one or more embodiments.

FIG. 6B is a flow diagram illustrating an integration view of the scambaiting system of FIGS. 1A-6A, according to one or more embodiments.

FIG. 7 is a diagram illustrating a profile view of the scambaiting system of FIGS. 1A-6B, according to one or more embodiments.

FIG. 8 is a process flow diagram illustrating the scambaiting system of FIGS. 1A-7, according to one or more embodiments.

FIG. 9 is a process flow diagram illustrating the scambaiting system of FIGS. 1A-7, according to one or more embodiments.

### DETAILED DESCRIPTION

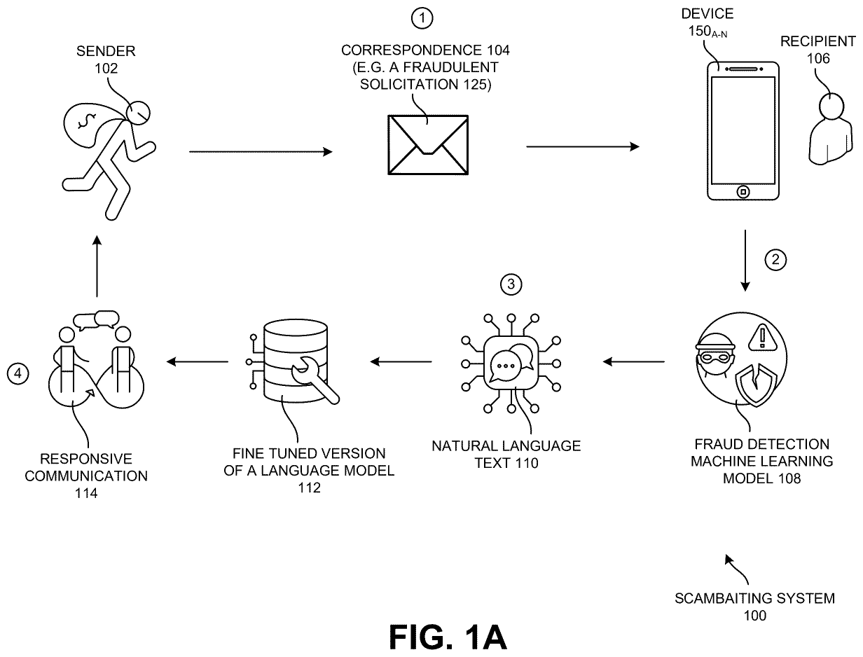

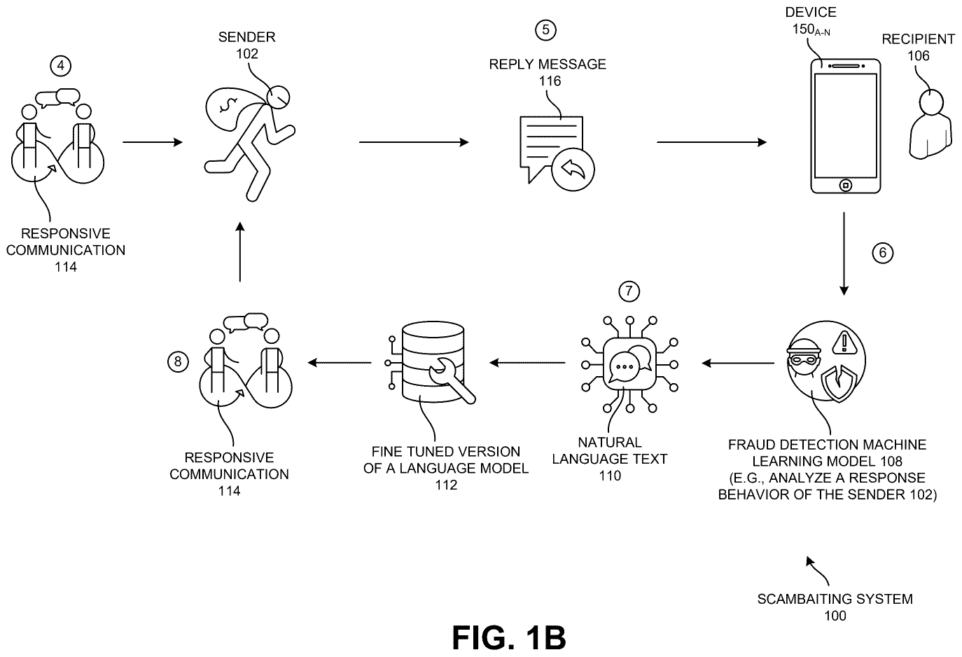

FIG. 1A is a flow diagram illustrating a scambaiting system 100 for detecting, analyzing, and responding to a correspondence 104 suspected of describing a fraudulent solicitation 125, according to one or more embodiments. FIG. 1A shows a sender 102, a correspondence 104, a recipient 106, a fraud detection machine learning model 108, a natural language text 110, a fine-tuned version of a language model 112, a responsive communication 114, and a device 150A-N.

The sender 102 may be an individual, group, and/or entity attempting to engage the recipient 106 in a fraudulent scheme and/or scam, according to one or more embodiments. The sender 102 may utilize various communication methods, including but not limited to email, text messages, phone calls, and/or instant messaging, to transmit a correspondence 104 to the recipient 106, according to one embodiment. The sender 102 may employ deceptive tactics, including but not limited to impersonation, emotional manipulation, and/or promises of financial gain, to elicit sensitive information, monetary transfers, and/or other actions that benefit the sender 102 at the expense of the recipient 106, according to one embodiment. The sender 102 may be identified and/or monitored by the scambaiting system 100 through the analysis of behavioral patterns, metadata, and/or the content of the correspondence 104.

The correspondence 104 may be a communication initiated by the sender 102, intended to deceive and/or engage the recipient 106 in a fraudulent scheme and/or scam. The correspondence 104 may take multiple forms, including but not limited to emails containing phishing links, text messages requesting account verification, phone calls soliciting personal information, and/or instant messages conveying fraudulent solicitations 125. The correspondence 104 may comprise natural language text 110, metadata 302 including but not limited to sender details, timestamps, phone numbers, instant message identifications, social media information, and/or embedded media, including but not limited to hyperlinks and/or attachments. The correspondence 104 may be prioritized for analysis by the fraud detection machine learning model 108 based on a unique identifier 306 including but not limited to contextual cues, detected patterns, and/or associated risk indicators.

The recipient 106 may be an individual, business entity, and/or organizational unit targeted by the sender 102, according to one or more embodiments. The recipient 106 may receive the correspondence 104 on one or more devices 150A-N, including but not limited to smartphones, computers, and/or other communication-enabled systems. The recipient 106 may be subjected to attempts by the sender 102 to elicit confidential information, financial assets, and/or other valuables. The scambaiting system 100 may interact with the recipient 106 by generating responsive communication 114, alerting the recipient 106 of suspected scams, and/or gathering information for further analysis.

The fraud detection machine learning model 108 may analyze the correspondence 104 within the scambaiting system 100 to identify various attributes (e.g., unique identifier 306) of fraudulent intent and/or generate actionable insights (e.g., analyze a response behavior of the sender 102) for downstream processing. The fraud detection machine learning model 108 may include various types of models, each contributing to the robust detection of scams as they are transmitted through email, text messages, phone-based transcriptions, and/or instant messaging platforms, according to one embodiment. The fraud detection machine learning model 108 may comprise various machine learning models including but not limited to supervised learning models, unsupervised learning models, reinforcement learning models, ensemble methods, and/or natural language processing (NLP)-specific architectures. By leveraging these diverse model types, the fraud detection machine learning model 108 may analyze correspondence 104 with a high degree of precision, enabling the system to detect complex and/or evolving scam tactics, according to one embodiment.

Supervised learning models within the fraud detection machine learning model 108 may utilize labeled training data comprising known scam messages, metadata from fraudulent communications, and/or annotated datasets provided by cybersecurity experts, according to one embodiment. These models may be trained to classify correspondence 104 based on its content, structure, and/or context, enabling the system to determine whether the correspondence 104 contains fraudulent intent, according to one embodiment. Unsupervised learning models may complement this process by detecting anomalies or deviations from typical communication patterns within the data, using clustering techniques and/or dimensionality reduction to identify unusual sender behaviors and/or message structures, according to one embodiment. According to one embodiment, if a scammer (e.g., the sender 102) attempts to obscure their tactics by mimicking legitimate communication patterns, the unsupervised models may detect subtle deviations that are not apparent in pre-labeled datasets.

Reinforcement learning models may further enhance the scambaiting system's 100 fraud detection capabilities by simulating scam scenarios and/or optimizing detection strategies through iterative feedback, according to one embodiment. The reinforcement models may allow the scambaiting system 100 to adapt dynamically to new scam methodologies by simulating how scammers (e.g., the sender 102) interact with potential victims (e.g., the recipient 106) and/or modifying detection policies based on observed outcomes, according to one embodiment. Ensemble models may aggregate outputs from supervised, unsupervised, and/or reinforcement learning approaches, ensuring that the fraud detection machine learning model 108 produces consistent and/or accurate results even when faced with ambiguous or incomplete data, according to one embodiment.

The natural language processing (NLP)-driven components of the fraud detection machine learning model 108 may process natural language extracted from correspondence 104, according to one embodiment. These components may include transformer-based architectures (e.g., BERT, GPT) and/or traditional models (e.g., Word2Vec) to analyze linguistic and contextual features unique to scam communications, according to one embodiment. According to one embodiment, NLP models may identify manipulative phrases, calls to action, and/or grammatical anomalies typical of fraudulent solicitations 125. The fraud detection machine learning model 108 may leverage contextual cues, including but not limited to metadata 302 and/or message format, alongside linguistic insights to generate a holistic analysis of correspondence 104.

In addition to analyzing natural language text 110, the fraud detection machine learning model 108 may also evaluate metadata 302 associated with correspondence 104, including but not limited to IP addresses, phone numbers, email addresses, timestamps, geolocation data, shared URLs, and/or sender-recipient relationships. According to one embodiment, metadata 302 may reveal patterns or discrepancies, including but not limited to repeated use of the same IP address for multiple correspondences 104 and/or mismatches between sender location and email domain, which may indicate fraudulent activity.

The fraud detection machine learning model 108 may be trained using diverse datasets curated to reflect the wide array of tactics employed by scammers, according to one embodiment. These datasets may include metadata 302 from identified scams, text-based datasets of scam messages, and/or adversarially generated examples that simulate novel fraud schemes, according to one embodiment. Training data may be derived from both historical records and/or real-time feedback collected by the scambaiting system 100, enabling continuous learning and/or adaptation, according to one embodiment.

The natural language text 110 may be the textual content extracted from the correspondence 104. The natural language text 110 may comprise a raw version of correspondence 316 (not shown) and/or a raw version of reply message 318 (not shown). The natural language text 110 may be an input for further analysis by the fraud detection machine learning model 108 and/or the fine-tuned version of the language model 112. The natural language text 110 may include, but is not limited to, the body of an email, the content of a text message, transcriptions of spoken communication in a phone call, and/or messages from instant messaging platforms. In addition to the primary message body, the natural language text 110 may include embedded content including but not limited to hyperlinks, hashtags, and/or quoted responses from prior conversations within a communication thread.

The natural language text 110 may be evaluated for a variety of characteristics including but not limited to keyword frequency, contextual risk markers, and/or sender metadata. Keyword frequency may be the occurrence of specific words and/or phrases commonly associated with scams, including but not limited to “urgent,” “prize,” and/or “account suspended.” Higher frequencies of such keywords may flag the correspondence 104 as potentially fraudulent. Contextual risk markers may be indicators including but not limited to the combination of keywords, linguistic tone, and/or structural patterns that suggest coercion, urgency, and/or manipulation, according to one embodiment. A phrase such as “click immediately to avoid account closure” may be identified as a high-risk combination due to its threatening tone and call-to-action, according to one embodiment.

The extraction of the natural language text 110 from the correspondence 104 may comprise various processing techniques including but not limited to parsing algorithms that segment and/or identify specific components of an email and/or message, optical character recognition (OCR) systems that convert text from images and/or scanned documents into digital format, and/or automated transcription systems that process audio data from phone calls into text, according to one embodiment. These extraction methods may be combined to ensure comprehensive and/or accurate retrieval of natural language text 110 from diverse communication formats, according to one embodiment.

The fine-tuned version of the language model 112 may be an advanced natural language processing model configured to analyze and/or interpret the natural language text 110 extracted from the correspondence 104. The fine-tuned version of the language model 112 may include architectures including but not limited to transformer-based models, recurrent neural networks, and/or probabilistic models. The fine-tuned version of the language model 112 may be trained on domain-specific datasets, including but not limited to annotated scam messages, metadata 302 from fraudulent communications, and/or linguistic patterns commonly associated with scams. Training of the fine-tuned version of the language model 112 may comprise processes including but not limited to supervised learning with labeled scam data, adversarial training to simulate evolving scam tactics, and/or continuous learning using real-time data inputs, according to one embodiment.

The fine-tuned version of the language model 112 may evaluate linguistic features including but not limited to syntax, semantics, sentiment, and/or context within the natural language text 110. The fine-tuned version of the language model 112 may detect manipulative and/or fraudulent intent by analyzing relationships between these features and/or contextual information extracted from the correspondence 104, according to one embodiment. The fine-tuned version of the language model 112 may interact with other system components including but not limited to the fraud detection machine learning model 108, to refine its outputs and/or contribute to the crafting of the responsive communication 114, according to one embodiment.

The responsive communication 114 may be a message generated by the fine-tuned version of the language model 112 in response to the correspondence 104. The responsive communication 114 may be crafted to mimic the behavior of a potential victim, prolonging interaction with the sender 102 while strategically extracting metadata 302 and/or information from the sender 102, according to one embodiment.

The responsive communication 114 may comprise content including but not limited to conversational inquiries, requests for clarification, and/or expressions of interest in the fraudulent offer. The responsive communication 114 may be designed to extract metadata 302, including but not limited to the sender's 102 IP address, geolocation, and/or response timing. Behavioral patterns, linguistic markers, and/or embedded structural details may also be identified and/or analyzed within the context of the responsive communication 114, according to one embodiment.

The responsive communication 114 may be dynamically adjusted based on the sender's 102 replies, leveraging real-time feedback and/or behavioral analytics to refine its content and/or engagement strategy, according to one embodiment. According to one embodiment, the fine-tuned version of the language model 112 may adapt the tone, urgency, and/or message format to elicit specific responses that provide actionable intelligence for further profiling of the sender 102, according to one embodiment. By generating and/or transmitting the responsive communication 114, the scambaiting system 100 may simultaneously waste the sender's 102 time and/or resources while gathering critical data for disrupting fraudulent operations.

The device 150A-N may be an electronic system associated with the recipient 106 and/or other users interacting with the scambaiting system 100. The device 150A-N may include but is not limited to smartphones, tablets, computers, and/or other communication-enabled devices capable of receiving the correspondence 104, according to one embodiment. The device 150A-N may facilitate the transmission and reception of responsive communication 114 and/or reply messages 116.

The device 150A-N may comprise components including but not limited to communication interfaces, processing units, and/or memory storage. Communication interfaces may enable the device 150A-N to send and/or receive data across networks, including but not limited to cellular networks, Wi-Fi, and/or Bluetooth, according to one embodiment. Processing units within the device 150A-N may execute instructions to interpret and/or display the correspondence 104 and/or responsive communication 114 for the recipient 106. Memory storage of the device 150A-N may retain data including but not limited to historical correspondences, metadata 302, and/or user-generated content for further analysis by the scambaiting system 100, according to one embodiment.

The device 150A-N may interact with other components of the scambaiting system 100, including the fine-tuned version of the language model 112 and/or the fraud detection machine learning model 108. According to one embodiment, the device 150A-N may serve as a medium for displaying alerts 204, engaging the sender 102 with responsive communication 114, and/or relaying metadata 302 to centralized databases for additional processing and analysis.

As shown in FIG. 1A, at ‘step-1’, a sender 102 transmits a correspondence 104 to the device 150A-N of a recipient 106, according to one embodiment. The correspondence 140 may be a fraudulent solicitation. At ‘step-2’, the scambaiting system 100 may identify one or more natural language text 110 of the correspondence 104 suspected of describing a fraudulent solicitation 125 using the fraud detection machine learning model 108 using a processor 506 and a memory 504, according to one embodiment. The correspondence 104 may be analyzed by the fraud detection machine learning model 108, which may examine the natural language text 110 (e.g., a raw version of the correspondence 316 and/or a raw version of the reply message 318) and/or associated metadata 302 (not shown) to determine whether the correspondence 104 contains indications of a fraudulent solicitation 125, according to one embodiment.

At ‘step-3’, if the fraud detection machine learning model 108 identifies the correspondence 104 as potentially fraudulent, the fraud detection machine learning model 108 may provide the analyzed natural language text 110 and/or metadata 302 (not shown) to the fine-tuned version of the language model 112 for further processing and/or analysis, according to one embodiment. Simultaneously, the recipient 106 may be alerted via the device 150A-N, with an alert 204 (not shown) indicating that the correspondence 104 is likely a scam, according to one embodiment. The alert 204 may comprise a visual and/or auditory notification, such as a “SCAM” warning displayed within the engagement hub 200 (not shown) and/or as an alert 204 on the device 150A-N, according to one embodiment.

At ‘step-4’, the fine-tuned version of the language model 112 may generate and/or transmit a responsive communication 114 to the sender 102, according to one embodiment. The responsive communication 114 may be crafted to mimic the behavior of a potential scam victim while also being strategically designed to extract additional metadata 302 and/or behavioral information from the sender 102, according to one embodiment. The responsive communication may be designed to initiate a recursive engagement from the sender 102 to prolong interaction and/or gather intelligence for further analysis, according to one embodiment.

FIG. 1B is a flow diagram illustrating a continuation of the scambaiting system 100 of FIG. 1A wherein a responsive communication 114 to a sender 102 may be crafted in a manner to encourage the sender to reply to the recipient 106 with a reply message 116, according to one or more embodiments. FIG. 1B shows the sender 102, the recipient 106, the fraud detection machine learning model 108, the natural language text 110, the fine-tuned version of the language model 112, the responsive communication 114, and the device 150A-N.

As shown in FIG. 1B, at ‘step-4’, as previously illustrated in FIG. 1A, the scambaiting system 100 transmits the responsive communication 114 from the device 150A-N of the recipient 106 to the sender 102, according to one embodiment. The responsive communication 114 may be designed to mimic the behavior of a potential victim while strategically eliciting further information from the sender 102, according to one embodiment.

At ‘step-5’, the sender 102 may reply to the responsive communication 114 with a reply message 116, according to one embodiment. The reply message 116 may include natural language text 110 and/or metadata 302, including but not limited to timestamps, geolocation data, and/or sender-specific identifiers, which the system collects for further analysis, according to one embodiment.

At ‘step-6’, the scambaiting system 100 may receive the reply message 116 at the device 150A-N of the recipient 106, according to one embodiment. The reply message 116 may be routed to the fraud detection machine learning model 108 for analysis, where the natural language text 110 and/or metadata 302 may be processed to identify additional behavioral patterns, linguistic markers, and/or risk indicators, according to one embodiment.

At ‘step-7’, the fraud detection machine learning model 108 may provide the natural language text 110 from the reply message 116 in a context window 202 to the fine-tuned version of the language model 112, according to one embodiment. The fine-tuned version of the language model 112, which may be optimized for scam phraseology, analyzes the natural language text 110 and contextual data from the reply message 116 to refine the engagement strategy and/or prepare subsequent communications, according to one embodiment.

At ‘step-8’, the fine-tuned version of the language model 112 generates a new responsive communication 114, which may be transmitted to the sender 102 by the scambaiting system 100, according to one embodiment. This transmission continues the recursive engagement with the sender 102, prolonging the interaction and subsequent collection of metadata 302 and/or behavioral information for additional analysis, according to one embodiment. Additionally, the recursive engagement wastes the sender's 102 time and/or resources, reducing their ability to target other potential victims, according to one embodiment.

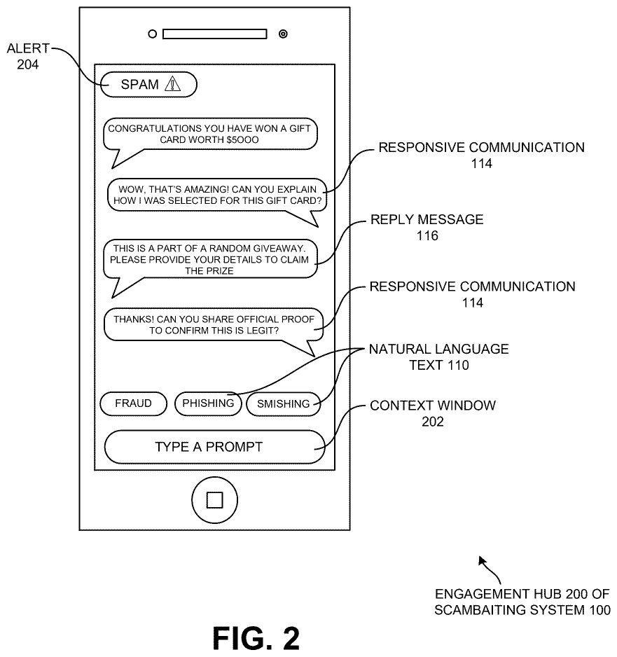

FIG. 2 is a diagram illustrating an engagement hub 200 of the scambaiting system 100 of FIGS. 1A-1B, according to one or more embodiments. FIG. 2 shows an engagement hub 200 comprising the natural language text 110, the responsive communication 114, the reply message 116, a context window 202, and an alert 204, according to one embodiment.

The engagement hub 200 may be an application installed on the device 150A-N that monitors messages across various communication platforms and/or facilitates scambaiting operations when executed locally from the recipient's 106 device. The engagement hub 200 may interact with the accessibility settings 602 of the device 150A-N to access and/or analyze messages within platforms including but not limited to text messaging applications, email clients, social media platforms, and/or instant messengers, according to one embodiment.

The engagement hub 200 may comprise functionalities including but not limited to real-time monitoring of incoming communications, prioritization of messages for analysis, and/or coordination with system components including but not limited to the fraud detection machine learning model 108 and/or the fine-tuned version of the language model 112, according to one embodiment. The engagement hub 200 may display responsive communication 114 and/or alerts 204 to the recipient 106 and facilitate their engagement with the sender 102, according to one embodiment.

When scambaiting is conducted from the recipient's 106 device 150A-N, the engagement hub 200 may serve as the central point for orchestrating interactions, extracting metadata 302, and/or relaying information to system components for further processing, according to one embodiment. The engagement hub 200 may also provide user-facing interfaces for managing scambaiting operations, enabling the recipient 106 to view, confirm, and/or terminate engagement with the sender 102, according to one embodiment.

The context window 202 may be the interface within the engagement hub 200 where the content of a correspondence 104 and/or a reply message 116 is presented and/or analyzed. The context window 202 may include the natural language text 110 extracted from the correspondence 104, the reply message 116, and/or additional metadata 302 associated with the communication, including but not limited to sender 102 details, timestamps, and/or platform-specific identifiers. The context window 202 may allow the recipient 106 to view the correspondence 104 and/or reply message 116 in real time, providing context for system-generated responsive communication 114 and/or alerts 204, according to one embodiment.

The context window 202 may represent the input interface within the scambaiting system 100, where information from the correspondence 104 and/or reply message 116 may be processed and/or provided to the fine-tuned version of the language model 112, according to one embodiment. The context window 202 may automatically populate with natural language text 110 and/or metadata 302 extracted from the correspondence 104 and/or a reply message 116, including but not limited to email content, text messages, timestamps, IP addresses, and/or sender identifiers, according to one embodiment.

The context window 202 may comprise a software-based interface that dynamically aggregates and/or organizes input data for analysis. This input data may be parsed and/or structured using processing algorithms integrated into the scambaiting system 100. The context window 202 may include fields and/or panels for displaying the natural language text 110, associated metadata 302, and/or a risk summary generated by the fraud detection machine learning model 108, according to one embodiment.

The context window 202 may interact directly with system components, including but not limited to the engagement hub 200 and/or accessibility settings 602, to extract information from correspondence 104 and/or a reply message 116 without manual intervention. This automated process may include steps including but not limited to reading email headers, transcribing audio messages into text, and/or parsing metadata attributes including but not limited to geolocation and/or timestamps, according to one embodiment. The extracted data may then be formatted and/or displayed within the context window 202, ready for analysis by the fine-tuned version of the language model 112, according to one embodiment.

The context window 202 may function as the operational workspace for the scambaiting system 100, enabling the fine-tuned version of the language model 112 to analyze the extracted inputs and/or generate responsive communication 114, according to one embodiment. The context window 202 may integrate seamlessly with machine learning workflows to provide a continuous stream of input data for processing. The context window 202 may prioritize certain correspondences 104 and/or reply messages 116 based on detected scam indicators, including but not limited to flagged keywords, unusual metadata patterns, and/or known fraudulent IP addresses, according to one embodiment.

Unlike manual input mechanisms, the context window 202 may operate automatically, requiring no direct input from the recipient 106, according to one embodiment. This automation may ensure efficiency by eliminating the need for manual review and/or intervention. The context window 202 may also dynamically update as recursive engagements with the sender 102 progress. According to one embodiment, as the sender 102 replies with a reply message 116, the context window 202 may refresh to display the new natural language text 110, updated metadata, and/or a recalibrated risk assessment.

To enhance usability, the context window 202 may include user-facing controls, including but not limited to options to view detailed scam analysis results, adjust engagement settings, and/or terminate ongoing interactions. These controls may assist the recipient 106 in overseeing and/or managing scambaiting operations, while the system performs the underlying automated processes, according to one embodiment.

The alert 204 may be a notification generated by the engagement hub 200 and displayed within the context window 202 and/or elsewhere on the device 150A-N, according to one embodiment. The alert 204 may indicate that the correspondence 104 has been identified as likely fraudulent by the scambaiting system 100, according to one embodiment. The alert 204 may comprise a visual indicator, including but not limited to the word “SPAM” displayed prominently, and/or additional contextual information, including but not limited to the level of risk and/or the type of scam detected, according to one embodiment.

The alert 204 may serve as an actionable element, allowing the recipient 106 to take further steps, including but not limited to initiating scambaiting actions, reporting the correspondence 104, and/or blocking the sender 102. The alert 204 may be dynamically generated based on the analysis performed by the fraud detection machine learning model 108 and may integrate insights derived from metadata 302, natural language text 110, and/or contextual risk markers, according to one embodiment.

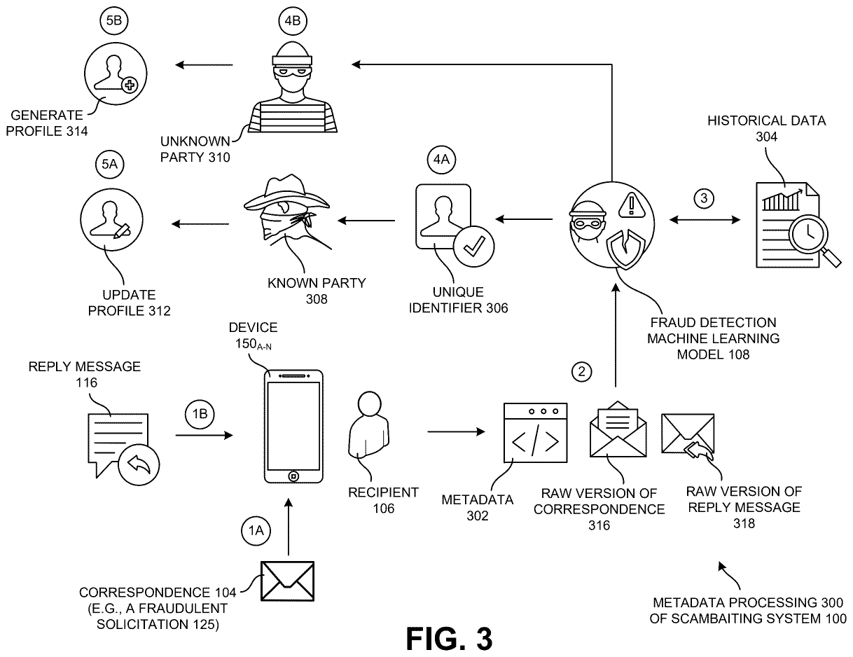

FIG. 3 is a flow diagram illustrating metadata processing 300 of the correspondence 104 (e.g., the raw version of the correspondence 316), the reply message 116 (e.g., the raw version of the reply message 318), metadata 302, and historical data 304 within the scambaiting system 100 of FIGS. 1A-2, according to one embodiment. FIG. 3 shows the correspondence 104 (e.g., a fraudulent solicitation 125), the recipient 106, the fraud detection machine learning model 108, the reply message 116, the device 150A-N, a metadata 302, a historical data 304, a unique identifier 306, a known party 308, an unknown party 310, an update profile 312, a generate profile 314, a raw version of the correspondence 316, and raw version of the reply message 318, a according to one embodiment.

The metadata processing 300 of the scambaiting system 100 may be a process in which the system distinguishes between an unknown party 310 and/or a known party 308, generates profiles 314, and/or updates profiles 314, according to one or more embodiments.

The metadata 302 may be information extracted from the correspondence 104 and/or reply message 116, which may aid in identifying and/or analyzing fraudulent activity. The metadata 302 may include but not be limited to IP addresses, phone numbers, email addresses, timestamps, geolocation data, message headers, user agent strings, and/or platform-specific identifiers associated with the sender 102, the correspondence 104, and/or the reply message 116. The metadata 302 may also comprise attributes including but not limited to message length, attachment types, hyperlink structures, and/or reply frequency. The metadata 302 may reveal patterns indicative of fraudulent behavior including but not limited to repeated use of the same IP address and/or inconsistencies between sender-reported geolocation and/or email domain, according to one embodiment.

The metadata 302 may be transformed into historical data 304 after processing by the scambaiting system 100. This transformation may comprise aggregating, normalizing, and/or analyzing the metadata 302 to identify correlations and/or trends which may be associated with scam-related activities. The metadata 302 may serve as a foundational input for the scambaiting system's 100 fraud detection processes and/or its ability to identify unknown parties 310 and/or establish unique identifiers 306, according to one embodiment.

The metadata 302 may be collected using mechanisms including but not limited to IP grabbers including but not limited to Grabify and/or other information scraping tools that may be integrated within the scambaiting system 100 and/or utilized through direct engagement with the sender 102, according to one embodiment. These tools may capture additional metadata by embedding trackable links, shortened URLs, and/or other resources within communications sent to the sender 102. Once engaged by the sender 102, these mechanisms may extract information including but not limited to the sender's 102 IP address, operating system, browser type, and/or approximate geolocation. This method of metadata collection may enhance the scambaiting system's 100 ability to uncover hidden attributes of the sender 102 and/or provide more granular insights for fraud detection and/or behavioral analysis.

The historical data 304 may comprise a repository of processed and/or enriched information derived from the metadata 302, the raw version of the correspondence 316, the raw version of the reply message 318, and/or other data sources including but not limited to web archives, publicly available information, and/or purchased datasets. The historical data 304 may support the scambaiting system's 100 detection, profiling, and/or engagement capabilities. The historical data 304 may comprise organized metadata 302 including but not limited to known scam behaviors, sender profiles, metadata attributes, and/or prior engagement outcomes. The historical data 304 may also comprise behavioral patterns, engagement records, and/or contextual insights generated from prior correspondences and/or system interactions, according to one embodiment.

The historical data 304 may be stored in a centralized database and may serve as a reference for comparing the correspondence 104 and/or the reply message 116 to prior fraudulent activity, according to one embodiment. The historical data 304 may include attributes which may comprise sender aliases, historical IP geolocations, and/or timestamps associated with past scams. The historical data 304 may enable the scambaiting system 100 to detect recurring scammers (e.g., a known party 308), unknown scammers (e.g., an unknown party 310), known organizations, known locations of senders, and/or non-scam solicitations. The historical data 304 may be used to train the scambaiting system 100 and/or to refine system algorithms for detecting fraudulent activities, according to one embodiment.

The unique identifier 306 may be an attribute which may identify related scam activities across multiple platforms and/or communications. The unique identifier 306 may be derived from metadata 302, historical data 304, and/or contextual features of the correspondence 104 and/or reply message 116, including but not limited to linguistic patterns and/or behavioral markers. The unique identifier 306 may enable the scambaiting system 100 to link disparate activities by the same sender 102 and/or fraud network, according to one embodiment.

The unique identifier 306 may comprise attributes including but not limited to hash values, pseudonyms, and/or other anonymized data points which may enable tracking and/or correlation of a sender's 102 activities. The unique identifier 306 may be dynamically updated as the scambaiting system 100 collects additional metadata 302 and/or historical data 304, according to one embodiment.

The known party 308 may be a sender 102 and/or entity whose fraudulent activities have been previously cataloged within the scambaiting system 100, according to one embodiment. The known party 308 may have an established record of prior activities (e.g., a profile 702) which may allow the scambaiting system 100 to preemptively flag incoming correspondence 104 and/or reply message 116 for further analysis, according to one embodiment.

The profile of the known party 308 may comprise information including but not be limited to associated aliases, preferred scam tactics, frequently used platforms, and/or prior interaction history with the scambaiting system 100. The known party's 308 data may allow the system to respond with tailored engagement strategies and/or preventative actions, according to one embodiment.

The unknown party 310 may be a sender 102 or entity whose activities may not yet have been cataloged within the scambaiting system 100. The unknown party 310 may lack an existing profile and may be analyzed using metadata 302, historical data 304, and/or contextual features of correspondence 104, according to one embodiment. The scambaiting system 100 may assess whether the unknown party 310 exhibits behaviors consistent with known fraudulent patterns, according to one embodiment.

The unknown party 310 may be transitioned to a known party 308 through the generate profile 314 process, which may compile their initial metadata 302, historical data 304, and/or observed behaviors into a profile 702, according to one embodiment. The generate profile 314 process may ensure that future correspondence 104 and/or reply messages 116 from the unknown party 310 may be flagged and/or addressed appropriately, according to one embodiment.

The update profile 312 process may comprise refining and/or expanding the profile 702 of a known party 308. The update profile 312 process may integrate new data including but not limited to new metadata 302, behavioral insights, and/or analytic outputs derived from ongoing engagements. The update profile 312 process may ensure that the known party's 308 profile remains current and/or comprehensive, according to one embodiment.

The update profile 312 process may also incorporate real-time information which may include but not be limited to additional scam messages (e.g., additional correspondences 104 and/or reply messages 116), updated unique identifiers 306, and/or newly identified aliases. The update profile 312 process may allow the scambaiting system 100 to maintain a robust and/or accurate record of the known party's 308 activities, according to one embodiment.

The generate profile 314 process may comprise creating a new profile for an unknown party 310 by aggregating metadata 302, analyzing metadata 302, aggregating historical data 304, and/or analyzing other observed behaviors. The generate profile 314 process may utilize inputs including but not limited to timestamps, platform identifiers, linguistic features, and/or other attributes extracted from the correspondence 104 and/or the reply message 116. The generate profile 314 process may also reference historical data 304 to determine whether the unknown party's 310 activities align with existing fraudulent patterns, according to one embodiment. The generate profile 314 process may enable the scambaiting system 100 to transition the unknown party 310 to a known party 308 and enhance its ability to detect, analyze, and/or respond to future fraudulent activities, according to one embodiment.

The raw version of the correspondence 316 may be a communication initiated by a sender 102, which may comprise unprocessed textual content and/or metadata 302. The raw version of the correspondence 316 may include natural language text 110 extracted from the correspondence 104, which may be transmitted through various platforms including but not limited to emails, text messages, phone-based transcriptions, and/or instant messaging applications. The raw version of the correspondence 316 may comprise embedded elements including but not limited to hyperlinks, timestamps, sender identification, and/or multimedia attachments, which may provide contextual information for downstream processing. The raw version of the correspondence 316 may be analyzed by the fraud detection machine learning model 108 to identify patterns, keywords, and/or anomalies indicative of fraudulent intent.

The raw version of the reply message 318 may be a communication initiated by the sender 102 in response to a prior message, including but not limited to the responsive communication 114 and/or the bait message 404. The raw version of the reply message 318 may comprise unprocessed textual content and/or metadata 302, which may include natural language text 110 provided by the sender 102. The raw version of the reply message 318 may further include elements including but not limited to timestamps, sender identification, and/or embedded media, which may offer insights into the sender's 102 behavior and/or intent. The raw version of the reply message 318 may serve as an input for further analysis by the fraud detection machine learning model 108 and/or other components of the scambaiting system 100.

As shown in FIG. 3, at ‘step-1A’ and ‘step-1B’, the correspondence 104 and/or the reply message 116 are transmitted to the device 150A-N of the recipient 106, according to one embodiment. The device 150A-N extracts metadata 302 from the correspondence 104 and/or reply message 116, including but not limited to IP addresses, timestamps, email addresses, and/or platform-specific identifiers, according to one embodiment.

At ‘step-2’, the metadata 302, the raw version of the correspondence 316, and/or the raw version of the reply message 318 may be transmitted to the fraud detection machine learning model 108 for analysis, according to one embodiment. The fraud detection machine learning model 108 evaluates the metadata 302, the raw version of the correspondence 316, and/or the raw version of the reply message 318 to determine whether they contain attributes indicative of fraudulent activity, according to one embodiment.

At ‘step-3’, the fraud detection machine learning model 108 compares the metadata 302, the raw version of the correspondence 316, and/or the raw version of the reply message 318 against historical data 304 stored in a centralized database (e.g., a historical database 510), according to one embodiment. The historical data 304 may include known scam behaviors, sender aliases, prior metadata attributes, and/or other contextual insights derived from previous correspondences, according to one embodiment. The fraud detection machine learning model 108 may also explore profiles 702 of known parties 308 to identify potential matches with the incoming metadata 302, the raw version of the correspondence 316, and/or the raw version of the reply message 318, according to one embodiment. This exploration helps determine whether the sender 102 may be previously cataloged and/or linked to prior fraudulent activities, according to one embodiment.

At ‘step-4A’, if the fraud detection machine learning model 108 identifies a match between the metadata 302, the raw version of the correspondence 316, and/or the raw version of the reply message 318 when compared to one or more unique identifier 306 in the historical data 304, the sender 102 may be classified as a known party 308, according to one embodiment. The unique identifier 306 may link the correspondence 104 and/or reply message 116 to an existing profile associated with the sender 102, enabling the system to flag the sender 102 as previously cataloged, according to one embodiment.

At ‘step-4B’, if the fraud detection machine learning model 108 does not detect a match between the metadata 302, the raw version of the correspondence 316, and/or the raw version of the reply message 318 when compared to one or more unique identifier 306 in the historical data 304, the sender 102 may be classified as an unknown party 310, according to one embodiment. The lack of a unique identifier 306 indicates that the sender 102 may not have been previously cataloged within the scambaiting system 100, according to one embodiment.

At ‘step-5A’, if the sender 102 is classified as a known party 308, the scambaiting system 100 may initiate the update profile 312 process, according to one embodiment. The update profile 312 process refines and/or expands the existing profile of the known party 308 by incorporating new metadata 302 extracted from the latest correspondence 104 and/or reply message 116, according to one embodiment. This ensures that the known party's 308 profile reflects the sender's 102 most recent behaviors, tactics, and/or metadata 302, according to one embodiment.

At ‘step-5B’, if the sender 102 may be classified as an unknown party 310, the scambaiting system 100 initiates the generate profile 314 process, according to one embodiment. The generate profile 314 process creates a new profile for the unknown party 310 by aggregating metadata 302, the raw version of the correspondence 316, the raw version of the reply message 318, and/or contextual information from the correspondence 104 and/or reply message 116, according to one embodiment. This profile 702 May include attributes including but not limited to timestamps, platform identifiers, linguistic features, and/or other metadata 302, which may be used for future detection and engagement, according to one embodiment.

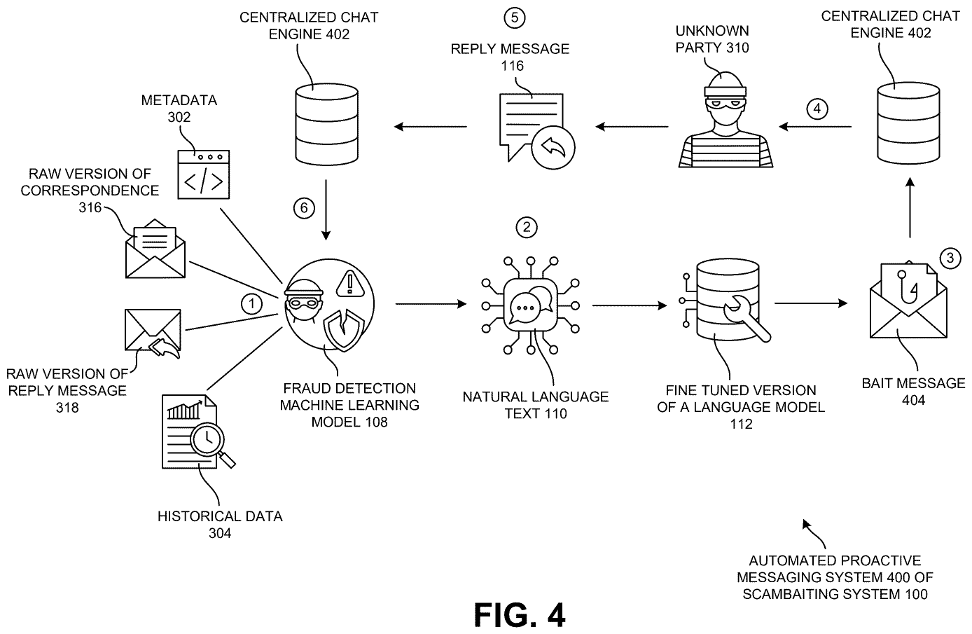

FIG. 4 is a flow diagram illustrating the generation and transmission of a bait message 404 by the scambaiting system 100 of FIGS. 1A-3, according to one or more embodiments. FIG. 4 shows an automated proactive messaging system 400 of scambaiting system 100 comprising the fraud detection machine learning model 108, the natural language text 110, the fine-tuned version of the language model 112, the reply message 116, the metadata 302, the historical data 304, the unknown party 310, the raw version of the correspondence 316, the raw version of the reply message 318, a centralized chat engine 402, and/or a bait message 404, according to one embodiment.

The automated proactive messaging system 400 may be the process and/or components used by the scambaiting system 100 to proactively engage with an unknown party 310 using a centralized infrastructure (e.g., the centralized chat engine 402), according to one embodiment. Unlike interactions conducted via the recipient's 106 device 150A-N, the automated proactive messaging system 400 may operate independently through a centralized chat engine 402, which may enable engagement with the unknown party 310 without any involvement from the recipient 106, according to one embodiment.

The automated proactive messaging system 400 may utilize the centralized chat engine 402 to access various communication platforms, including but not limited to email, messengers, and/or voice calls, according to one embodiment. The system may transmit bait messages 404 designed to elicit replies from the unknown party 310 while strategically gathering metadata 302 and/or behavioral insights from the raw version of the correspondence 316, and/or the raw version of the reply message 318, according to one embodiment. The automated proactive messaging system 400 may operate autonomously to disrupt the operations of the unknown party 310, prolonging engagement and extracting actionable intelligence for further analysis and system refinement, according to one embodiment.

The centralized chat engine 402 may be a server-based module within the scambaiting system 100 that facilitates proactive engagement with the unknown party 310, according to one embodiment. The centralized chat engine 402 may operate entirely independently of the recipient 106 and the recipient's device 150A-N, according to one embodiment. Unlike interactions that occur through the recipient's 106 device 150A-N, the centralized chat engine 402 functions from a remote computer and/or server located at a site completely separate from the recipient's 106 device 150A-N and physical location, according to one embodiment.

The centralized chat engine 402 may utilize metadata 302, the historical data 304, the raw version of the correspondence 316, and/or the raw version of the reply message 318 collected during prior communications between the recipient 106 and the sender 102 to confirm that the sender 102 is an unknown party 310, according to one embodiment. Once the unknown party 310 is identified, the centralized chat engine 402 autonomously engages with the unknown party 310 by generating and transmitting bait messages 404, according to one embodiment. The centralized chat engine 402 may access communication platforms including but not limited to email, messengers, and/or phone calls, mimicking the methods used by the device 150A-N without any further involvement or interaction by the recipient 106, according to one embodiment.

The centralized chat engine 402 may comprise components including but not limited to communication interfaces, scheduling algorithms, and/or data storage modules, which may facilitate seamless and/or continuous interactions with the unknown party 310, according to one embodiment. These components may operate entirely from a remote location, ensuring no interaction between the recipient 106 and/or the centralized chat engine 402 during the engagement process, according to one embodiment.

The centralized chat engine 402 may coordinate with other components of the scambaiting system 100, including but not limited to the fraud detection machine learning model 108 and/or the fine-tuned version of the language model 112, to analyze replies (e.g., the reply message 116) received from the unknown party 310, refine engagement strategies, and/or extract metadata 302 and/or behavioral insights, according to one embodiment. The centralized chat engine 402 may dynamically adapt its communications to sustain engagement and/or maximize disruption to the unknown party's 310 fraudulent activities, according to one embodiment.

The bait message 404 may be a communication generated by the scambaiting system 100 and transmitted to the unknown party 310 via the centralized chat engine 402, according to one embodiment. The bait message 404 may be crafted to appear as though it originates from a legitimate and/or interested recipient, encouraging the unknown party 310 to continue the interaction and disclose additional information, according to one embodiment. The bait 404 message may be crafted to encourage the unknown party 310 to reply to the bait message 404 with a reply message 116, according to one embodiment.

The bait message 404 may comprise content including but not limited to inquiries, confirmations, and/or expressions of interest designed to mimic genuine engagement while strategically gathering metadata 302, the raw version of the correspondence 316, the raw version of the reply message 318, and/or behavioral data from the unknown party 310, according to one embodiment. The bait message 404 may be dynamically generated using outputs from the fine-tuned version of the language model 112, which may analyze the context of the correspondence 104 to tailor the message content, tone, and/or urgency, according to one embodiment.

The bait message 404 may serve multiple purposes, including wasting the unknown party's 310 time and/or resources while extracting critical insights into their methods, metadata 302, and/or behavioral patterns, according to one embodiment. These insights may be used to refine historical data 304, train the fraud detection machine learning model 108, and/or improve the system's ability to detect and engage with fraudulent actors in the future, according to one embodiment.

As shown in FIG. 4, at ‘step-1’, the fraud detection machine learning model 108 processes metadata 302 from the reply message 116 and/or correspondence 104, according to one embodiment. Furthermore, at ‘step-1’, the fraud detection machine learning model 108 processes the natural language text 110 (e.g., raw version of the correspondence 316, and/or the raw version of the reply message 318), according to one embodiment. Furthermore, at ‘step-1’, the fraud detection machine learning model 108 compares this metadata 302, the raw version of the correspondence 316, and/or the raw version of the reply message 318 against historical data 304 stored in a centralized database (e.g., the historical database 510) and determines that the sender 102 is an unknown party 310, according to one embodiment.

At ‘step-2’, the natural language text 110 (e.g., the raw version of the correspondence 316, and/or the raw version of the reply message 318) and/or metadata 302 extracted from the correspondence 104 and/or reply message 116 may be provided as input to the fine-tuned version of the language model 112, according to one embodiment. The natural language text 110 may also be analyzed to extract metadata-like insights, including but not limited to linguistic tone, sentiment markers, and/or keyword frequency, which may complement traditional metadata 302 during processing, according to one embodiment. These insights help tailor the system's engagement strategies, according to one embodiment.

At ‘step-3’, the fine-tuned version of the language model 112 generates a bait message 404 based on the analysis of the natural language text 110 and contextual metadata 302, according to one embodiment. The bait message 404 may be crafted to appear as though it originates from a legitimate and/or interested recipient 106, while strategically designed to extract additional metadata 302 and/or behavioral information from the unknown party 310, according to one embodiment. The bait message 404 may then transmitted to the centralized chat engine 402, according to one embodiment.

At ‘step-4’, the centralized chat engine 402 autonomously sends the bait message 404 to the unknown party 310 using communication platforms including but not limited to email, instant messaging apps, and/or phone calls, according to one embodiment. This engagement occurs entirely independently of the recipient 106 and the device 150A-N, according to one embodiment.

At ‘step-5’, the unknown party 310 may reply to the bait message 404 by sending a reply message 116 to the centralized chat engine 402, according to one embodiment. The reply message 116 may include natural language text 110 and/or metadata 302, such as timestamps, geolocation information, and/or linguistic markers derived from the text content, according to one embodiment.

At ‘step-6’, the centralized chat engine 402 transmits the reply message 116, including the natural language text 110 and/or metadata 302, to the fraud detection machine learning model 108 for further analysis, according to one embodiment. This recursive process may continue in a loop, with the scambaiting system 100 dynamically adapting the bait message 404 and/or engagement strategies to maximize disruption of the unknown party's 310 activities while collecting actionable intelligence, according to one embodiment.

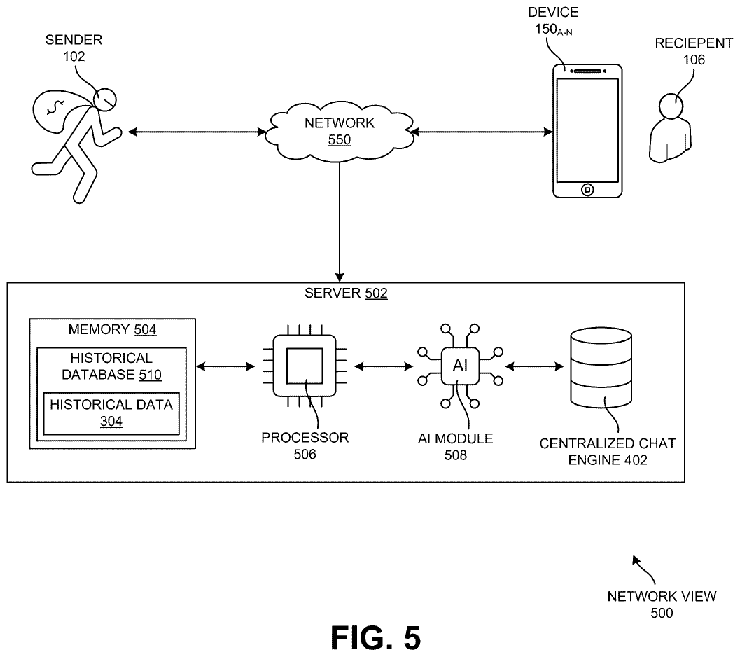

FIG. 5 is a network view 500 illustrating the infrastructure of the scambaiting system 100 of FIGS. 1A-4, according to one or more embodiments. FIG. 5 shows the sender 102, the recipient 106, the device 150A-N, a server 502, a memory 504 comprising a historical database 510, a processor 506, an AI module 508, and a network 550.

The server 502 may be a centralized computing system within the scambaiting system 100, configured to manage data storage, processing, and communication with external devices, according to one embodiment. The server 502 may house components including but not limited to the memory 504, the processor 506, and the AI module 508, enabling it to perform critical tasks such as storing historical data 304, analyzing metadata 302, and/or generating responsive communications 114, according to one embodiment. The server 502 may operate remotely, independently of the recipient 106 and/or the device 150A-N, according to one embodiment.

The server 502 may interact with other components of the scambaiting system 100 over the network 550 to process correspondence 104, reply messages 116, and/or bait messages 404. This interaction ensures seamless coordination between the centralized chat engine 402, the fine-tuned version of the language model 112, and other system modules, according to one embodiment.

The memory 504 may comprise a storage module within the server 502 used to retain data and/or execute system operations, according to one embodiment. The memory 504 may include the historical database 510, which may store organized metadata 302, natural language text 110, unique identifiers 306, and/or behavioral profiles of known parties 308 and/or unknown parties 310, according to one embodiment.

The memory 504 may facilitate data retrieval and storage for use by the processor 506 and/or the AI module 508, according to one embodiment. According to one embodiment, the memory 504 may store scam detection models, bait message templates, and/or engagement logs for future analysis and system refinement.

The processor 506 may be a computational unit within the server 502 responsible for executing tasks related to scam detection, data analysis, and engagement, according to one embodiment. The processor 506 may execute instructions stored in the memory 504, enabling the server 502 to coordinate activities including but not limited to analyzing metadata 302, processing natural language text 110, and/or generating bait messages 404, according to one embodiment.

The processor 506 may comprise various types of processors, including but not limited to central processing units (CPUs) for general-purpose computing, graphics processing units (GPUs) optimized for parallel data processing, and/or tensor processing units (TPUs) designed to accelerate machine learning and/or deep learning operations. The processor 506 may also include application-specific integrated circuits (ASICs) for specialized tasks including but not limited to neural network computations and/or field-programmable gate arrays (FPGAs) configured for workload-specific operations. The processor 506 may interact with other components including but not limited to the AI module 508 and/or the memory 504 to execute fraud detection workflows, generate system outputs, and/or facilitate communication over the network 550, according to one embodiment.

The AI module 508 may be a computational system within the server 502 designed to execute artificial intelligence and machine learning models for scam detection, engagement, and system optimization, according to one embodiment. The AI module 508 may comprise the core AI components of the scambaiting system 100, including but not limited to the fraud detection machine learning model 108, which analyzes metadata 302, natural language text 110, and/or reply messages 116 to detect fraudulent intent, and/or the fine-tuned version of the language model 112, which generates responsive communication 114 and/or bait messages 404 tailored to specific scam contexts, according to one embodiment.

The AI module 508 may also include behavioral pattern analysis models that analyze sender actions to infer strategies and/or identify recurring tactics, and/or adaptive learning algorithms that refine system outputs based on real-time feedback from ongoing engagements, according to one embodiment. The AI module 508 may interact with the historical database 510, the processor 506, and/or the centralized chat engine 402 to refine engagement strategies, enhance detection accuracy, and/or improve the overall performance of the scambaiting system 100, according to one embodiment.

As shown in FIG. 5, the sender 102 may interact with the device 150 (and thus the recipient 106) and/or the server 502 via the network 550. The network 550 may facilitate communication between the sender 102 and recipient 106, enabling the exchange of the correspondence 104, the responsive communication 114, the bait message 404, and/or the reply message 116.

The server 502 may comprise several components, including but not limited to the centralized chat engine 402, a processor 506, an AI module 508, a memory 504, and/or a historical database 510 comprising the historical data 304. The processor 506 may execute various computational tasks including but not limited to natural language processing, metadata analysis, and/or fraud detection. The AI module 508 may perform advanced machine learning-based tasks, including but not limited to analyzing correspondence for fraudulent patterns, identifying scam-related behaviors, and/or generating dynamic responses, according to one embodiment. The memory 504 may store operational data, including but not limited to intermediate results and/or runtime parameters, while the historical database 510 may archive long-term records of correspondence and/or sender-receiver interactions (e.g., historical data 304) to support behavioral analysis and/or future reference. These components may collectively process incoming messages, analyze metadata, and/or provide fraud detection and/or scambaiting functionalities.

The server 502 may also integrate the centralized chat engine 402, which may enable seamless communication between the automated proactive messaging system 400 of the scambaiting system 100 and the sender 100 (e.g., one of the unknown party 310 and/or the known party 308), and facilitate the processing of correspondence, reply messages, and/or associated metadata, according to one embodiment. Not all computing and/or processing must occur on the external server 502, according to one embodiment. Some and/or all of these functionalities, including but not limited to fraud detection, metadata analysis, and/or response generation, may occur locally on the device 150, according to one embodiment.

The device 150 may utilize its local processor, memory, and/or software to execute these operations, including but not limited to extracting metadata 302, analyzing the natural language text 110, and/or tracking interactions, according to one embodiment. This distributed computing capability may enhance system flexibility and/or efficiency, which may reduce latency and/or dependency on external network connectivity. The server 502 may serve as a supplemental resource, providing additional computational power or acting as a repository for historical data 304, according to one embodiment.

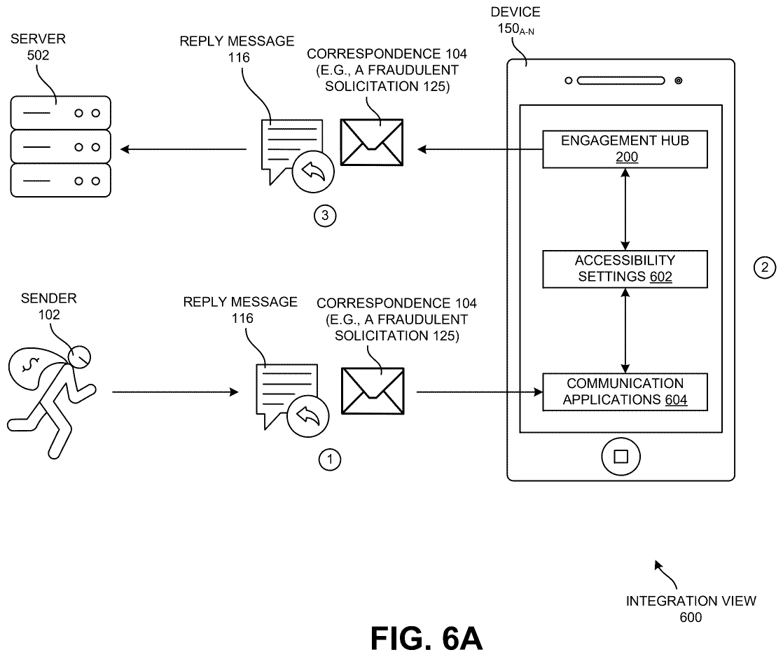

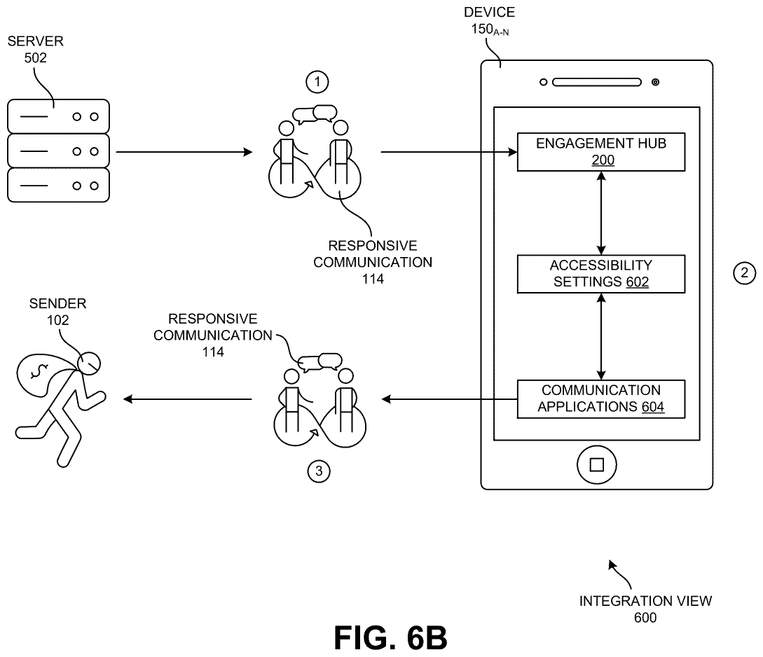

FIG. 6A is a flow diagram illustrating an integration view 600 of the scambaiting system of FIGS. 1-5, according to one or more embodiments. FIG. 6A shows the integration view 600 comprising the sender 102, the reply message 116, the device 150A-N, the engagement hub 200, the server 502, an accessibility setting(s) 602, and a communication application(s) 604.

The accessibility settings 602 may be device-level features commonly available in major operating systems, such as Windows, macOS, iOS, and Android, which may be designed to enhance usability for individuals with disabilities, according to one embodiment. These accessibility settings 602 may provide tools and/or functionalities that enable software systems to interact with on-screen elements, voice commands, and/or keyboard navigation programmatically, according to one embodiment. Accessibility settings 602 may include features including but not limited to screen readers, which convert text displayed on a screen into speech and/or Braille, enabling the scambaiting system 100 to extract natural language text 110 and/or metadata 302 from communication applications 604, according to one embodiment.

Additionally, text-to-speech converters may enable the system to access and/or vocalize message content automatically, according to one embodiment. Accessibility settings 602 may further include automation APIs, including but not limited to Apple's Accessibility API, Android's Accessibility Services, and/or Windows UI Automation, which allow the scambaiting system 100 to interact with on-screen elements programmatically by retrieving message content, pressing virtual buttons, and/or navigating communication applications 604, according to one embodiment. Keyboard emulation and/or input simulation may also be employed, allowing the system to send responses and/or perform actions within communication applications 604 by mimicking user input, according to one embodiment.

The scambaiting system 100 may leverage accessibility settings 602 to create a bridge between the engagement hub 200 and/or communication applications 604, enabling automated interaction and seamless data exchange, according to one embodiment. Through these accessibility settings 602, the engagement hub 200 may access message data displayed within communication applications 604, extract natural language text 110 and/or metadata 302, and transmit the responsive communication 114 without requiring manual input from the recipient 106, according to one embodiment.

The scambaiting system 100 may use accessibility settings 602 to detect and parse an incoming communication from the send 102 within a messaging application, extract sender information and message content, and transmit this data to the fraud detection machine learning model 108 for analysis, according to one embodiment. Similarly, the system may use accessibility APIs of the accessibility settings 602 to send bait messages 404 through one or more communication application 604, according to one embodiment. By integrating with accessibility settings 602, the scambaiting system 100 may achieve automated monitoring, data extraction, and/or engagement while maintaining compatibility with the underlying operating system and applications, according to one embodiment.

The communication applications 604 may include platforms and/or software used for transmitting and/or receiving messages, according to one embodiment. The communication applications 604 may include but not be limited to text messaging platforms, email clients, social media messengers, and/or voice call systems, according to one embodiment. The communication applications 604 may serve as the primary medium for correspondence 104 and/or reply messages 116, providing the scambaiting system 100 with access to sender 102 and/or recipient 106 interactions, according to one embodiment.

The communication applications 604 may interface with the engagement hub 200 via accessibility settings 602, enabling the scambaiting system 100 to analyze and/or respond to incoming messages automatically, according to one embodiment. This integration allows the scambaiting system 100 to transmit responsive communication 114, monitor metadata 302, and/or extract behavioral insights from reply messages 116 for further analysis, according to one embodiment.

As shown in FIG. 6A, at ‘step-1’, the sender 102 transmits a correspondence 104 and/or reply message 116 to a communication application 604 operating on the device 150A-N of the recipient 106, according to one embodiment. The correspondence 104 and/or reply message 116 may include natural language text 110 and/or metadata 302, including but not limited to timestamps, sender identifiers, IP addresses, and/or geolocation data, according to one embodiment. The communication application 604 receives and stores the incoming correspondence 104 and/or reply message 116 as part of its standard functionality, according to one embodiment.

At ‘step-2’, the scambaiting system 100 continuously monitors the communication application 604 through accessibility settings 602, according to one embodiment. These accessibility settings 602 allow the scambaiting system 100 to detect when a correspondence 104 and/or reply message 116 may be received by the communication application 604. This monitoring may include observing on-screen notifications, reading message contents programmatically, and/or accessing application data through device-level automation interfaces, according to one embodiment.

At ‘step-3’, the engagement hub 200, which may operate as an intermediary application, facilitates the transmission of the natural language text 110 and/or metadata 302 from the communication application 604 to the server 502 via the network 550, according to one embodiment. The engagement hub 200 may act as a bridge between the user-facing components of the scambaiting system 100 and/or its backend infrastructure, ensuring that data from the communication application 604 may be sent securely and efficiently to the server 502, according to one embodiment. The network 550 may include wired and/or wireless communication channels, such as the Internet, cellular networks, and/or private communication networks, to enable this transmission, according to one embodiment.

Upon receiving the natural language text 110 and/or metadata 302 from the engagement hub 200, the server 502, which comprises components including the memory 504, processor 506, AI module 508, and/or historical database 510, begins processing the data, according to one embodiment. This processing may involve analyzing the metadata 302 for patterns indicative of fraudulent activity using the fraud detection machine learning model 108, as well as using the fine-tuned version of the language model 112 to evaluate the natural language text 110 for scam-related content and generate responsive communication 114, according to one embodiment.

FIG. 6B is a flow diagram illustrating an integration view 600 of the scambaiting system 100 of FIGS. 1-6A, according to one or more embodiments. FIG. 6B shows the integration view 600 comprising the sender 102, the responsive communication 114, the device 150A-N, the engagement hub 200, the server 502, an accessibility setting(s) 602, and a communication application(s) 604, according to one embodiment.

At ‘step-1’, the server 502, which may comprise components including but not limited to the fraud detection machine learning model 108 and/or the fine-tuned version of the language model 112, generates a responsive communication 114 based on prior analysis of the natural language text 110 and/or metadata 302, according to one embodiment. Alternatively, the fraud detection machine learning model 108 and/or the fine-tuned version of the language model 112 may operate solely on the device 150A-N without the need for accessing the server 502, according to one embodiment. The responsive communication 114 may be crafted to appear as though it originates from a legitimate and/or interested recipient 106 and/or may be designed to sustain engagement with the sender 102 while gathering additional metadata 302 and/or behavioral insights, according to one embodiment. Once generated, the responsive communication 114 may be transmitted from the server 502 to the engagement hub 200 via the network 550, according to one embodiment.

At ‘step-2’, the engagement hub 200 receives the responsive communication 114 and acts as a bridge to facilitate its delivery to the sender 102, according to one embodiment. The engagement hub 200 utilizes accessibility settings 602 on the device 150A-N to input the responsive communication 114 into the communication application 604, according to one embodiment. These accessibility settings 602 allow the engagement hub 200 to programmatically interact with the communication application 604, performing actions including but not limited to opening the application, navigating to the appropriate message interface, and/or pasting the responsive communication 114 into the message field, according to one embodiment.

At ‘step-3’, the communication application 604 transmits the responsive communication 114 to the sender 102 via the appropriate communication platform, according to one embodiment. This transmission may occur over a variety of channels, including but not limited to email, text messaging services, and/or social media messaging, according to one embodiment. The sender 102 receives the responsive communication 114, which appears as though it has been sent directly from the recipient 106, enabling the scambaiting system 100 to continue engagement and disrupt fraudulent operations, according to one embodiment.

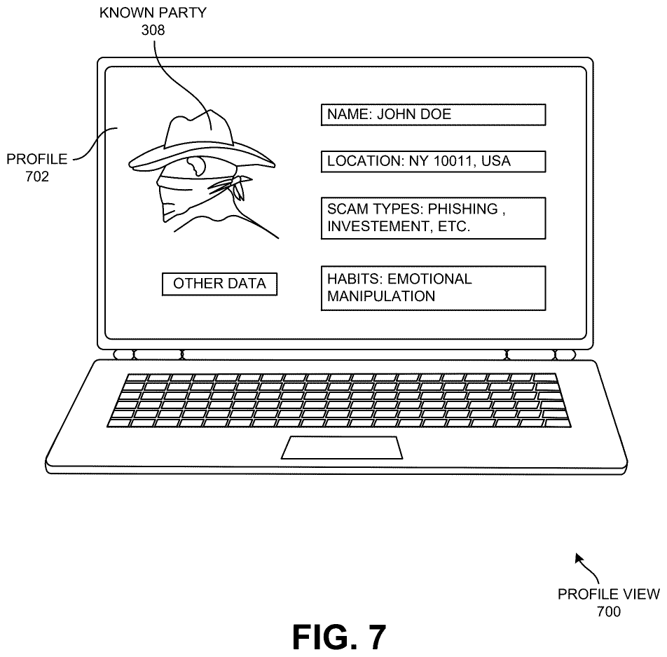

FIG. 7 is a diagram illustrating a profile view 700 of the scambaiting system of FIGS. 1-6B, according to one or more embodiments. FIG. 7 shows the profile view 700 comprising the known party 702 and the profile 702.

The profile 702 may be a digital representation of a known party 308, which may comprise various attributes and historical data 304 related to the known party's 308 activities and/or behaviors. The profile 702 may include personal information including but not limited to a name, location, and/or other identifying characteristics. The profile 702 may further comprise metadata 302 and/or information regarding scam types associated with the known party 308, including but not limited to phishing, investment schemes, and/or other forms of fraudulent activities.

The profile 702 may store behavioral patterns, which may include habits including but not limited to emotional manipulation, linguistic preferences, and/or time-of-day activity trends. The profile 702 may further include one or more unique identifiers 306, raw versions of the correspondence 316 and/or the raw versions of the reply message 318 associated with prior communications, according to one embodiment. The raw versions of the correspondence 316 and/or the raw versions of the reply message 318 may enable the scambaiting system 100 to perform detailed analysis of language, metadata, and/or interaction history.

The profile 702 may integrate additional data points, including but not limited to cross-platform identifiers, timestamps of interactions, and/or frequency of correspondence. These elements may allow the system to predict, analyze, and/or respond to future engagements with the known party 308. The profile 702 may be dynamically updated based on new interactions and/or metadata 302 collected from communications. Updates may be stored within the memory 504 for future reference and/or analysis. The profile 702 may be accessible through various devices including but not limited to computers, phones, tablets, and/or laptops, which may display detailed records of past fraudulent activities, behavioral tendencies, and/or contextual insights.

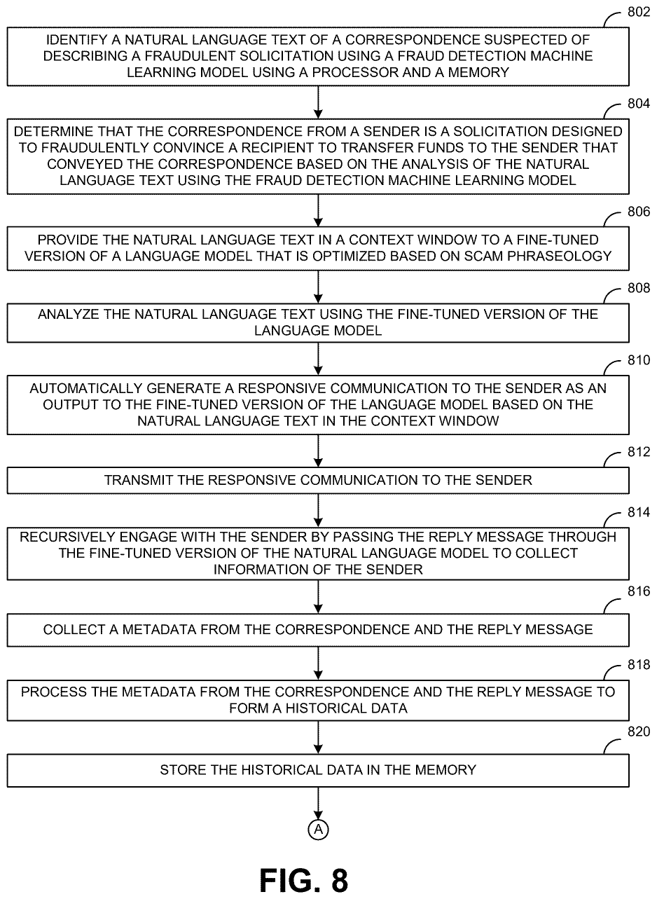

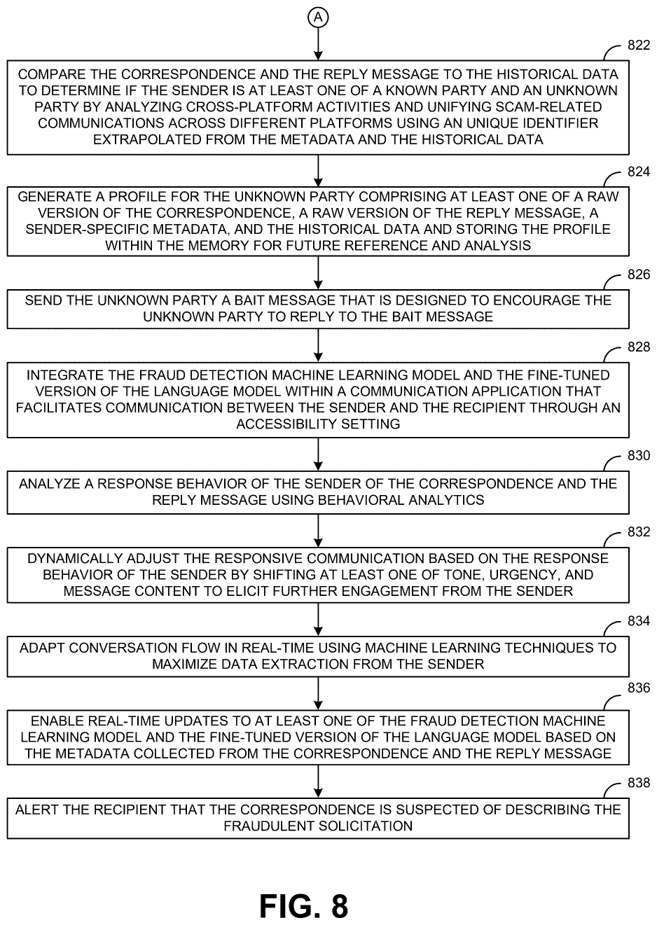

FIG. 8 is a process flow diagram illustrating the scambaiting system 100 of FIGS. 1-7, according to one or more embodiments. In operation 802, the scambaiting system 100 may identify a natural language text 110 of a correspondence 104 suspected of describing a fraudulent solicitation 125 using a fraud detection machine learning model 108 using a processor 506 and a memory 504. In operation 804, the scambaiting system 100 may determine that the correspondence 104 from a sender 102 is a solicitation designed to fraudulently convince a recipient 106 to transfer funds to the sender 102 that conveyed the correspondence 104 based on the analysis of the natural language text 110 using the fraud detection machine learning model 108.

In operation 806, the scambaiting system 100 may provide the natural language text 110 in a context window 202 to a fine-tuned version of a language model 112 that is optimized based on scam phraseology. In operation 808, the scambaiting system 100 may analyze the natural language text 110 using the fine-tuned version of the language model 112.

In operation 810, the scambaiting system 100 may automatically generate a responsive communication 114 to the sender 102 as an output to the fine-tuned version of the language model 112 based on the natural language text 110 in the context window 202. In operation 812, the scambaiting system 100 may transmit the responsive communication 114 to the sender 102. In operation 814, the scambaiting system 100 may recursively engage with the sender 102 by passing the reply message 116 through the fine-tuned version of the natural language model 112 to collect information of the sender 102.

In operation 816, the scambaiting system 100 may collect metadata 302 from the correspondence 104 and/or the reply message 116. In operation 818, the scambaiting system 100 may process the metadata 302 from the correspondence 104 and/or the reply message 116 to form historical data 304. In operation 820, the scambaiting system 100 may store the historical data 304 in the memory 504.

In operation 822, the scambaiting system 100 may compare the correspondence 104 and/or the reply message 116 to the historical data 304 to determine if the sender 102 is at least one of a known party 308 and an unknown party 310 by analyzing cross-platform activities and/or unifying scam-related communications across different platforms using a unique identifier 306 extrapolated from the metadata 302 and the historical data 304. In operation 824, the scambaiting system 100 may generate a profile 314 for the unknown party 310 comprising at least one of a raw version of the correspondence 316, a raw version of the reply message 318, sender-specific metadata 302, and historical data 304 and/or storing the profile within the memory 504 for future reference and analysis.

In operation 826, the scambaiting system 100 may send the unknown party 310 a bait message 404 that is designed to encourage the unknown party 310 to reply to the bait message 404. In operation 828, the scambaiting system 100 may integrate the fraud detection machine learning model 108 and/or the fine-tuned version of the language model 112 within a communication application 604 that facilitates communication between the sender 102 and the recipient 106 through an accessibility setting 602. In operation 830, the scambaiting system 100 may analyze a response behavior of the sender 102 of the correspondence 104 and/or the reply message 116 using behavioral analytics.

In operation 832, the scambaiting system 100 may dynamically adjust the responsive communication 114 based on the response behavior of the sender 102 by shifting at least one of tone, urgency, and/or message content to elicit further engagement from the sender 102. In operation 834, the scambaiting system 100 may adapt conversation flow in real-time using machine learning techniques to maximize data extraction from the sender 102. In operation 836, the scambaiting system 100 may enable real-time updates to at least one of the fraud detection machine learning model 108 and/or the fine-tuned version of the language model 112 based on metadata 302 collected from the correspondence 104 and/or the reply message 116. In operation 838, the scambaiting system 100 may alert 204 the recipient 106 that the correspondence 104 is suspected of describing a fraudulent solicitation 125.

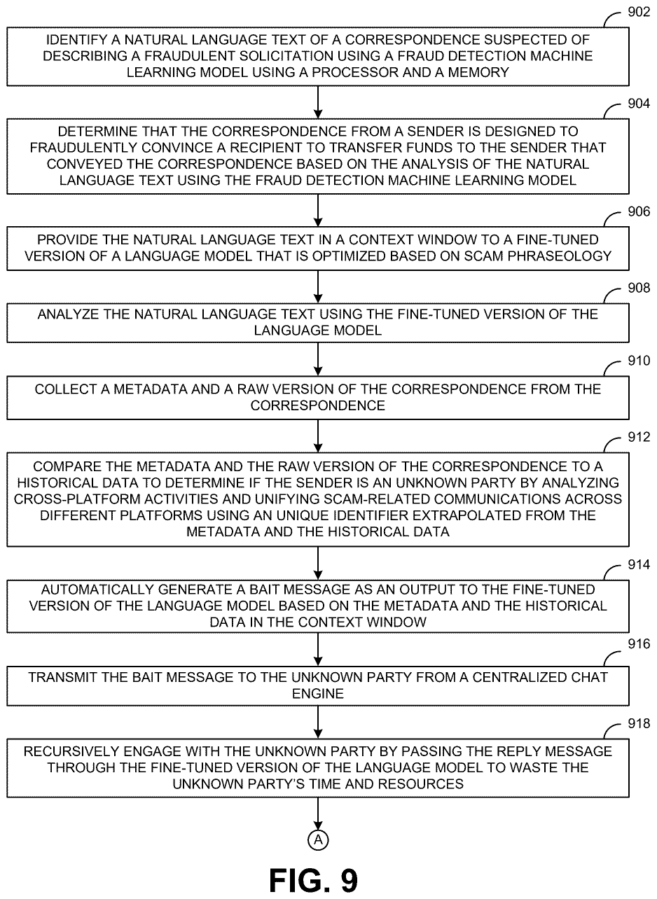

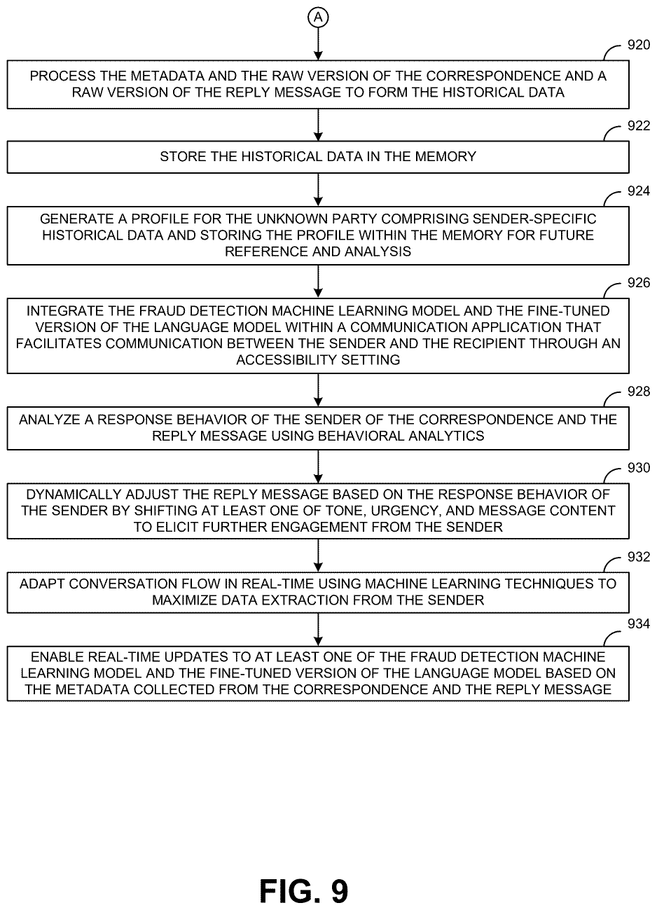

FIG. 9 is a process flow diagram illustrating the scambaiting system 100 of FIGS. 1A-7, according to one or more embodiments. In operation 902, the scambaiting system 100 may identify a natural language text 110 of a correspondence 104 suspected of describing a fraudulent solicitation 125 using a fraud detection machine learning model 108 using a processor 506 and a memory 504.

In operation 904, the scambaiting system 100 may determine that the correspondence 104 from a sender 102 is designed to fraudulently convince a recipient 106 to transfer funds to the sender 102 that conveyed the correspondence 104 based on the analysis of the natural language text 110 using the fraud detection machine learning model 108. In operation 906, the scambaiting system 100 may provide the natural language text 110 in a context window 202 to a fine-tuned version of a language model 112 that is optimized based on scam phraseology.

In operation 908, the scambaiting system 100 may analyze the natural language text 110 using the fine-tuned version of the language model 112. In operation 910, the scambaiting system 100 may collect metadata 302 and/or a raw version of the correspondence 316 from the correspondence 104.

In operation 912, the scambaiting system 100 may compare the metadata 302 and/or the raw version of the correspondence 316 to a historical data 304 to determine if the sender 102 is an unknown party 310 by analyzing cross-platform activities and/or unifying scam-related communications across different platforms using a unique identifier 306 extrapolated from the metadata 302 and/or the historical data 304. In operation 914, the scambaiting system 100 may automatically generate a bait message 404 as an output to the fine-tuned version of the language model 112 based on the metadata 302 and/or the historical data 304 in a context window 202.

In operation 916, the scambaiting system 100 may transmit the bait message 404 to the unknown party 310 from a centralized chat engine 402. In operation 918, the scambaiting system 100 may recursively engage with the unknown party 310 by passing the reply message 116 through the fine-tuned version of the language model 112 to waste the unknown party's 310 time and/or resources.

In operation 920, the scambaiting system 100 may process the metadata 302 and/or the raw version of the correspondence 316 and/or a raw version of the reply message 318 to form historical data 304. In operation 922, the scambaiting system 100 may store the historical data 304 in the memory 504. In operation 924, the scambaiting system 100 may generate a profile 314 for the unknown party 310 comprising sender-specific historical data 304 and/or storing the profile within the memory 504 for future reference and/or analysis. In operation 926, the scambaiting system 100 may integrate the fraud detection machine learning model 108 and/or the fine-tuned version of the language model 112 within a communication application that facilitates communication between the sender 102 and/or the recipient 106 through an accessibility setting 602.

In operation 928, the scambaiting system 100 may analyze a response behavior of the sender 102 of the correspondence 104 and/or the reply message 116 using behavioral analytics. In operation 930, the scambaiting system 100 may dynamically adjust the bait message 404 based on the response behavior of the sender 102 by shifting at least one of tone, urgency, and/or message content to elicit further engagement from the sender 102. In operation 932, the scambaiting system 100 may adapt conversation flow in real-time using machine learning techniques to maximize data extraction from the sender 102. In operation 934, the scambaiting system 100 may enable real-time updates to at least one of the fraud detection machine learning model 108 and/or the fine-tuned version of the language model 112 based on metadata 302 collected from the correspondence 104 and/or the reply message 116.

The following is a plain english example of the scambating system 100.

Jim is a senior citizen who enjoys keeping in touch with his family and friends using his smartphone, according to one embodiment. Over the years, Jim has installed several communication applications on his phone, including social media messengers, encrypted messaging platforms, multiple email accounts, text messaging services, and phone call capabilities, according to one embodiment. Concerned about the growing number of scam messages targeting senior citizens, Jim's children urged him to download The Scandan Proactive Scambaiting System to protect himself from fraudulent actors, according to one embodiment.

After downloading and installing The Scandan Proactive Scambaiting System, Jim was prompted to grant the application access to the accessibility settings on his smartphone, according to one embodiment. By enabling these settings, The Scandan Proactive Scambaiting System could seamlessly monitor and/or interact with all of Jim's communication applications without requiring manual input from Jim himself, according to one embodiment. The application integrated into Jim's phone via the engagement hub, which acted as a bridge between his device and the backend components of The Scandan Proactive Scambaiting System, according to one embodiment. Within days of setting up the application, Jim received a suspicious text message on one of his messaging applications, according to one embodiment. The message read: “You have a package at the post office that was not delivered to your home because no one answered the front door. Please click THIS LINK and enter your information to determine where to pick up your package,” according to one embodiment.

Almost immediately after the text arrived, The Scandan Proactive Scambaiting System flagged it as a scam, according to one embodiment. An alert popped up on Jim's phone, accompanied by a notification sound and a red banner at the top of his screen that read “SCAM DETECTED: This message is likely fraudulent,” according to one embodiment. The alert provided additional details, such as the sender's phone number, the type of scam detected (e.g., phishing for personal information), and recommended actions for Jim, such as blocking the sender, according to one embodiment.

The Scandan Proactive Scambaiting System identified the message as a scam by analyzing its content and metadata using its fraud detection machine learning model, according to one embodiment. This model, trained on a robust dataset of historical scam communications, identified suspicious patterns in the message, according to one embodiment. For example, the model flagged the phrases “click THIS LINK” and “enter your information” as manipulative language commonly associated with phishing scams, according to one embodiment. The system also extracted metadata, such as the sender's phone number and timestamps, and compared it against historical data in its centralized database, according to one embodiment. Upon finding no match with known parties, the system flagged the sender as an unknown party, according to one embodiment. Simultaneously, the fine-tuned version of the language model processed the natural language text in the message to assess its intent, detecting urgency and grammatical patterns typical of scam attempts, according to one embodiment. These coordinated analyses culminated in the system generating an alert for Jim, while autonomously initiating a response to the sender, according to one embodiment.

As Jim read the alert, he noticed that The Scandan Proactive Scambaiting System had already begun engaging with the scammer, according to one embodiment. The engagement hub displayed the back-and-forth messaging between The Scandan Proactive Scambaiting System and the scammer in real time, according to one embodiment. The system sent a response such as: “Oh no! I wasn't home yesterday. Can you resend the link? I think I deleted it by accident!” according to one embodiment.

On the backend, the scambaiting system continued analyzing metadata from the correspondence and subsequent reply messages using the fraud detection machine learning model, according to one embodiment. This metadata, including timestamps, IP addresses, and geolocation information, was cross-referenced with historical data to identify potential links to known parties, according to one embodiment. After additional analysis, the system classified the sender as an unknown party, as no matches were found in its database, according to one embodiment.

Once identified as an unknown party, The Scandan Proactive Scambaiting System initiated a new phase of engagement through its centralized chat engine, according to one embodiment. The centralized chat engine, operating independently of Jim and his device, used a phone number not associated with Jim to send a bait message to the unknown party, according to one embodiment. The bait message, crafted using a fine-tuned version of a language model, leveraged the context of Jim's interaction to maximize engagement, according to one embodiment. The system sent a message such as: “I'm really worried about my package! Can you confirm if there's a fee I need to pay to get it? Let me know right away.” The unknown party replied with: “No worries, the new link is HERE: [suspicious link].” according to one embodiment.

This reply message was analyzed by the fraud detection machine learning model, which extracted metadata such as the sender's location and the structure of the suspicious link, according to one embodiment. The natural language text was then processed by the fine-tuned version of the language model, which generated a new bait message: “Thank you! The link isn't opening for me. Can you double-check it? I'm not very good with technology,” according to one embodiment

This iterative process continued, with The Scandan Proactive Scambaiting System dynamically crafting responses to sustain engagement and extract further behavioral insights from the unknown party, according to one embodiment.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system. Accordingly, the specification and drawings are to be regarded in an illustrative rather than a restrictive sense.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A computer-implemented method comprising:
receiving, by a processor, a correspondence comprising a natural language text and associated metadata extracted from the correspondence
generating, by a fraud detection machine learning model stored in a memory and trained using a supervised learning dataset comprising labeled scam messages and historical metadata, a fraud-likelihood classification for the natural-language text;
determining, based on the fraud-likelihood classification, that the correspondence from a sender is a fraudulent solicitation designed to convince a recipient to transfer funds;
providing the natural-language text in a context window to a task-specific fine-tuned transformer-based language model, the transformer-based language model having been fine-tuned using a training dataset annotated with scam-specific phraseology, metadata patterns, and behavioral examples;
analyzing, by the fine-tuned transformer-based language model, the natural language text within the context window to generate contextual linguistic features;
automatically generating, by the fine-tuned transformer-based language model and within a predefined response-generation time constraint, a responsive communication crafted to encourage the sender to reply;
transmitting the responsive communication to the sender;
receiving a reply message from the sender and recursively processing the reply message by inputting the reply message into the fine-tuned transformer-based language model to extract behavioral and linguistic indicators associated with the sender;
collecting the metadata from the correspondence and the reply message;
processing the metadata from the correspondence and the reply message to form historical data stored in the memory, the historical data comprising temporal, platform-specific, and sender-specific metadata attributes;
comparing the correspondence, the reply message, and the historical data to determine whether the sender corresponds to a known party or an unknown party using a unique identifier derived from the metadata and historical data;
updating, in response to determining that the sender corresponds to an unknown party, a sender profile stored in the memory using the historical data and the extracted behavioral indicators; and
monitoring, by an engagement hub executed locally on a device comprising the processor and the memory, messages across multiple communication platforms by interacting with an accessibility interface of the device to access and analyze the correspondence and the reply message.

2. The method of claim 1 further comprising:
collecting, by the processor, the metadata from the correspondence and the reply message, the metadata comprising one or more of IP addresses, timestamps, email addresses, geolocation data, message headers, user-agent strings, hyperlink structures, and reply frequency.

3. The method of claim 2 further comprising:
processing, by the device, the metadata from the correspondence and the reply message to form the historical data by aggregating normalizing, and analyzing the metadata to identify correlations or trends associated with scam-related activities; and
storing the historical data in the memory.

4. The method of claim 1 further comprising:
comparing, by the device, the correspondence, the reply message, and the historical data to determine if the sender is at least one of a known party and an unknown party by analyzing cross-platform activities and unifying scam-related communications across different platforms using the unique identifier derived from the metadata, the historical data, and contextual features of the correspondence.

5. The method of claim 4 further comprising:
generating, by the device, a profile for the unknown party comprising at least one of a raw version of the correspondence, a raw version of the reply message, a sender-specific metadata, and the historical data, and storing the profile within the memory for future reference and analysis,
wherein generating the profile transitions the unknown party into a known party.

6. The method of claim 4 further comprising:
sending, by the processor, the unknown party a bait message that is designed to encourage the unknown party to reply to the bait message and to extract behavioral and metadata attributes.

7. The method of claim 6 further comprising:
wherein sending the bait message comprises transmitting the bait message from a centralized chat engine that is not associated with the recipient.

8. The method of claim 1 further comprising:
integrating the fraud detection machine learning model and the fine-tuned transformer-based language model within a communication application to facilitate communication between the sender and the recipient through an accessibility interface of the device.

9. The method of claim 1 further comprising:
analyzing, by the device, a response behavior of the sender of the correspondence and the reply message using behavioral analytics derived from metadata, timing patterns, linguistic markers, and contextual features.

10. The method of claim 1 further comprising:
dynamically adjusting, by the device, the responsive communication based on the response behavior of the sender by modifying at least one of tone, urgency, contextual framing, and message content to elicit further engagement from the sender.

11. The method of claim 1 further comprising:
adapting, by the device, conversation flow in real-time using machine learning techniques that incorporate updated metadata, linguistic inputs, and behavioral indicators to maximize data extraction from the sender.

12. The method of claim 1 further comprising:
enabling, by the device, real-time updates to at least one of the fraud detection machine learning model and the fine-tuned transformer-based language model based on the metadata collected from the correspondence and the reply message.

13. The method of claim 1 further comprising:
alerting, by the device, the recipient, via a dynamically generated alert, that the correspondence is suspected of describing the fraudulent solicitation based on the fraud-likelihood classification.

14. A computer-implemented method for distracting a scammer, the method comprising:
receiving, by a processor, a correspondence comprising a natural language text and associated metadata extracted from the correspondence;
generating, by a fraud detection machine learning model stored in a memory and trained using labeled scam messages and metadata from fraudulent communications, a fraud-likelihood classification for the natural-language text;
determining, based on the fraud-likelihood classification, that the correspondence from a sender is a fraudulent solicitation intended to convince a recipient to transfer funds;
providing the natural language text in a context window to a task-specific fine-tuned transformer-based language model having been fine-tuned using domain-specific datasets including annotated scam messages and metadata from fraudulent communications;
analyzing, by the fine-tuned transformer-based language model the natural language text in the context window to generate contextual linguistic features;
executing, on a device, instructions stored in the memory by the processor, the device comprising the processor and the memory that store and execute the fraud detection machine-learning model and the task-specific fine-tuned transformer-based language model;
collecting a metadata and a raw version of the correspondence the metadata comprising one or more of IP addresses, timestamps, email addresses, geolocation data, message headers, user-agent strings, hyperlink structures, and reply frequency;
comparing the metadata and the raw version of the correspondence to a historical data stored in the memory to determine whether the sender corresponds to an unknown party, the comparing comprising applying a unique identifier derived from the metadata, the historical data, and contextual features of the correspondence;
automatically generating, by the fine-tuned transformer-based language model, a bait message based on the metadata, the historical data, and the contextual linguistic features within the context window, the bait message crafted to encourage the unknown party to reply with a reply message,
transmitting the bait message to the unknown party from a centralized chat engine that is not associated with the recipient;
recursively engaging with the unknown party by receiving the reply message and processing the reply message using the fine-tuned transformer-based language model to extract additional metadata and behavioral indicators to prolong the interaction and thereby waste the unknown party's time and resources.

15. The method of claim 14 further comprising:
processing, by the device, the metadata, the raw version of the correspondence, and a raw version of the reply message to form the historical data by aggregating, normalizing, and analyzing the metadata to identify correlations associated with scam-related activity;
and
storing the historical data in the memory.

16. The method of claim 14 further comprising:
generating, by the device, a profile for the unknown party comprising sender-specific historical data metadata attributes, and behavioral markers derived from the correspondence and reply message, and storing the profile within the memory for future reference and analysis,
wherein generating the profile transitions the unknown party into a known party.

17. The method of claim 14 further comprising:
integrating the fraud detection machine learning model and the fine-tuned transformer-based language model within a communication application configured to facilitate communication between the sender and the recipient through an accessibility interface of the device.

18. The method of claim 14 further comprising:
analyzing, by the device, a response behavior of the sender of the correspondence and the reply message using behavioral analytics derived from metadata attributes, timing patterns, and linguistic markers; and
dynamically adjusting the bait message based on the response behavior of the sender by modifying at least one of tone, urgency, contextual framing, and message content to elicit further engagement from the sender.

19. The method of claim 14 further comprising:
adapting, by the device, conversation flow in real-time using machine learning techniques that incorporate updated metadata, linguistic features, and behavioral indicators to maximize data extraction from the sender.

20. The method of claim 14 further comprising:
enabling, by the device, real-time updates to at least one of the fraud detection machine learning model and the fine-tuned transformer-based language model based on the metadata collected from the correspondence and the reply message.
